(19) United States
(12) Patent Application Publication
(10) Pub. No.: US 2025/0299294 A1
(43) Pub. Date: Sep. 25, 2025

(54) IMAGE PROCESSING METHOD, AND STORAGE MEDIUM

(71) Applicant: CANON KABUSHIKI KAISHA, Tokyo (JP)

(72) Inventors: YOSHIAKI IDA, Saitama (JP); YUKINO ONO, Tochigi (JP); YUICHI KUSUMI, Tochigi (JP)

(21) Appl. No.: 19/063,441

(22) Filed: Feb. 26, 2025

(30) Foreign Application Priority Data
Mar. 19, 2024 (JP) 2024-042985
Mar. 19, 2024 (JP) 2024-043029

(51) Int. Cl. G06T 3/4046; G06T 3/4007; G06T 7/246

(52) U.S. Cl. CPC G06T 3/4046; G06T 3/4007; G06T 7/246; G06T 2207/20021; G06T 2207/20081; G06T 2207/20084

(57) ABSTRACT

An image processing method includes acquiring, based on a first image set including a first image and a second image of a first size, a second image set of a second size smaller than the first size, which corresponds to partial areas of the first image set, and acquiring a motion vector by inputting the second image set into a machine learning model. The motion vector is a motion vector in the second image based on the first image. The machine learning model is trained using a third image set of a third size. The second size is equal to or smaller than a fourth size. The fourth size is set based on the third size.

### BACKGROUND

### Technical Field

The present disclosure relates to an image processing method, and a storage medium.

### Description of Related Art

In image processing using a machine learning model, a technique for estimating a motion vector (optical flow) is known. Japanese Patent Application Laid-Open No. 2018-156640 discloses a training method of a machine learning model that estimates an optical flow between temporally adjacent frames (images) that constitute a moving image.

As an image processing method using a motion vector, “Mehdi S M Sajjadi, Raviteja Vemulapalli, and Matthew Brown, Frame-recurrent video super-resolution. In Proceedings of the IEEE Conference on Computer Vision and Pattern Recognition (CVPR), pages 6626-6634, 2018” discloses a method in which a reference frame and an adjacent frame included in a moving image are input into a first machine learning model to generate a motion vector between the reference frame and the adjacent frame, and the motion vector is enlarged by bilinear interpolation. This method upscales the reference frame by inputting the enlarged motion vector, the reference frame, and the adjacent frame upscaled by a second machine learning model into a second machine learning model.

An image processing method according to one aspect of the disclosure includes acquiring, based on a first image set including a first image and a second image of a first size, a second image set of a second size smaller than the first size, which corresponds to partial areas of the first image set, and acquiring a motion vector by inputting the second image set into a machine learning model. The motion vector is a motion vector in the second image based on the first image. The machine learning model is trained using a third image set of a third size. The second size is equal to or smaller than a fourth size. The fourth size is set based on the third size. A non-transitory computer-readable storage medium storing a program that causes a computer to execute the above image processing method also constitutes another aspect of the disclosure.

An image processing method according to another aspect of the disclosure includes reducing a first image and a second image that include at least a portion of a same object at different positions and generating a third image corresponding to the first image and a fourth image corresponding to the second image, generating a first motion vector based on the third image and the fourth image using a first machine learning model, generating a second motion vector by enlarging the first motion vector, and generating a fifth image based on the first image, the second image, and the second motion vector using a second machine learning model. A non-transitory computer-readable storage medium storing a program that causes a computer to execute the above image processing method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a flowchart of a training method according to Example 1.

FIG. 2 is a flowchart of an estimation method according to Example 1.

FIG. 3 illustrates a relationship between an input image set and divided areas according to Example 1.

FIG. 4 explains image processing according to Example 2.

FIG. 5 is a flowchart of a training method according to Example 2.

FIG. 6 is a flowchart of an estimation method according to Example 2.

FIG. 7 is a block diagram of an image processing system according to each example.

FIG. 8 illustrates the flow of an estimation phase according to Example 3.

FIG. 9 illustrates the conventional flow of executing a machine learning task using motion vectors generated by a machine learning model.

FIG. 10 is a block diagram illustrating the configuration of an image processing system according to Example 3.

FIG. 11 is an external view of the image processing system according to Example 3.

FIG. 12 is a flowchart illustrating generating processing of training data for a first machine learning model according to Example 3.

FIG. 13 is a flowchart illustrating training processing of a weight of the first machine learning model according to Example 3 (first training phase).

FIG. 14 is a flowchart illustrating generating processing of training data for a second machine learning model according to Example 3.

FIG. 15 is a flowchart illustrating training processing of a weight of the second machine learning model according to Example 3 (second training phase).

FIG. 16 is a flowchart regarding an estimation phase according to Example 3.

FIG. 17 is a block diagram illustrating the configuration of an image processing system according to Example 4.

FIG. 18 is an external view of the image processing system according to Example 4.

FIG. 19 is a flowchart illustrating generating processing of training data for a second machine learning model according to Example 4.

FIG. 20 is a flowchart illustrating training processing of a weight of the second machine learning model according to Example 4 (second training phase).

FIG. 21 illustrates a flow of an estimation phase according to Example 4.

FIG. 22 is a flowchart illustrating processing of the estimation phase according to Example 4.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific example, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of examples according to the disclosure. Corresponding elements in respective figures will be designated by the same reference numerals, and a duplicate description thereof will be omitted.

An image processing unit according to one embodiment performs motion vector estimation processing using a machine learning model for an input image set. Here, the image set includes a plurality of images including at least a first image and a second image, and may be an image pair consisting of two images, a first image and a second image. The motion vector is a motion vector of the second image based on the first image, and corresponds to a difference in position of the same object commonly included in each image (the first image and the second image) included in the image set. The motion vector is estimated using two images (still images), such as images (frames) at different times in a moving image (moving image data), stereoscopic images acquired from different viewpoints, or a plurality of continuously shot images.

The motion vector is also called an optical flow. The motion vector is acquired, for example, as a map corresponding to an image. Each pixel value of the map is a value of a position shift amount along a predetermined direction, and represents the position shift in different images based on one image. In stereoscopic matching, it may be acquired as a single map having values in only one direction, or more generally, it may be acquired as a map corresponding to a plurality of directions, such as the horizontal and vertical directions of the image.

Estimating the optical flow can provide object tracking in moving images, parallax amount estimation between stereoscopic images, and alignment among a plurality of images. Using the alignment to concatenate (combine) a plurality of images can provide noise reduction through image concatenation processing, and sharpening and resolution improvement (enhancement) based on a sampling difference for the same object. The position interpolation can be used for processing of increasing a frame rate of a moving image.

To train a machine learning model that performs motion vector estimation processing, ground-truth motion vector data is used for an image set that includes a plurality of images. Motion vector data measured for a captured image may be used, or computer graphics (CG) data with known motion vector values may be used. For example, in a stereoscopic image, a parallax amount can be calculated by measuring distance information, so the ground-truth motion vector data can be obtained. An image set is input into a machine learning model such as a neural network to estimate a motion vector, and the parameters of the machine learning model may be optimized so as to reduce a difference from the ground-truth motion vector. Training can also be performed by unsupervised learning, which has no ground-truth motion vector. For example, two images are input into a machine learning model to estimate a motion vector, a geometric transformation based on the estimated motion vector is applied to one of the two images, and the parameters of the machine learning model are optimized so as to reduce a difference from the other image.

Each example estimates a motion vector between different frames that constitute a moving image, but a target of the motion vector estimation is not limited to different frames that constitute a moving image.

Problems of this embodiment will now be described in detail. In a case where the input size of the machine learning model for image processing is variable, the image size (third size) input into the model during training and the image size that is used for estimation by the trained model may differ from each other. On the other hand, the weight information (parameters) on the machine learning model is updated based on the image size that is used for training. Therefore, in a case where the image size input into the model during estimation is larger than the image size during training (or the reference image size), the estimation accuracy by the machine learning model decreases.

For example, in a convolutional neural network, in a case where a convolutional filter uses (refers to) values outside an image for calculation, the image may be padded with zeros or a fixed value. Hence, the convolutional filter is trained only based on the padded values outside the image.

However, in a case where the image size input into the model during estimation is larger than the image size that is used during training, pixel values according to the scene contained in the image are input, unlike padding. Inputting an image with a condition different from that of training reduces the estimation accuracy. On the other hand, in a case where the image size input into the model during estimation is smaller than the image size that is used during training, the model has been trained on images of various scenes, so padding the image during estimation does not lower the estimation accuracy.

In a case where the convolutional filter is 3×3, the only pixels that refer to the outside of the image are the pixels at the very periphery of the image. Hence, only the most peripheral pixels can lower the estimation accuracy. However, including a plurality of layers of convolution processing increases the area of the input image that is indirectly referred to. Thus, the area of the input image that a machine learning model indirectly refers to in processing a specific pixel is called a receptive field. In a neural network with three convolutional layers of 3×3 filters, the receptive field has a 7×7 area.

As the number of layers in the neural network increases, the receptive field expands and more pixels are referred to outside the image. As the size of the receptive field increases, the machine learning model can consider a wider area of the input image, but in a case where the image size input into the model during estimation is larger than the image size during training (or the reference image size), the area size of the image where estimation accuracy decreases also increases.

This problem depends on the image processing task performed by the machine learning model. For example, resolution improvement (upscaling) is processing that corrects degradation during interpolation, but this processing can be corrected based on only local information. As another example, processing that corrects aberrations in an optical system that has captured an image can be corrected based on local image areas affected by the aberrations. Thus, in image processing tasks that can be performed based on pixel values of relatively small image areas, even if the receptive field of the machine learning model is large, the parameters of the machine learning model can be trained to emphasize image areas smaller than the image size that is used for training. Therefore, even if the image size that is used for estimation is larger than the image size that is used for training, this problem is likely to occur because the machine learning model does not emphasize only small image areas.

In these image correction tasks, in a case where image degradation is expressed as convolution, the degradation kernel is determined independently of the object. Therefore, the image size for correction can be previously assumed and the image size during training can be determined. Therefore, in an image correction task in which the degradation to be corrected does not depend on the global structure of the object, the image size during training can be set large for the image area that the machine learning model emphasizes, so the above problem is unlikely to occur.

On the other hand, in an image processing task that estimates a motion vector of an object, the upper limit of the size of the motion vector is not determined, and it is necessary to estimate it based on a wider area of the image than the above task. The machine learning model is trained to estimate the motion vector based on pixel values of a wider area. The estimation accuracy decreases in a case where an image size larger than the image size during training is input for estimation. The image size that is used during training is limited to a size smaller than the predetermined size according to the memory capacity of the processing apparatus (e.g., Graphics Processing Unit (GPU)) that is used during training, the training time, or the size of the training data set. In a case where a resolution-improved image is input during estimation, the image larger than the size of the training image is input, and the motion vector estimation accuracy decreases.

In a case where the training data set does not include large movements, the image area that the machine learning model emphasizes is localized, so the accuracy does not decrease even if the input image size increases. On the other hand, the accuracy decreases in estimating large movements. Each example will be described in detail below.

### Example 1

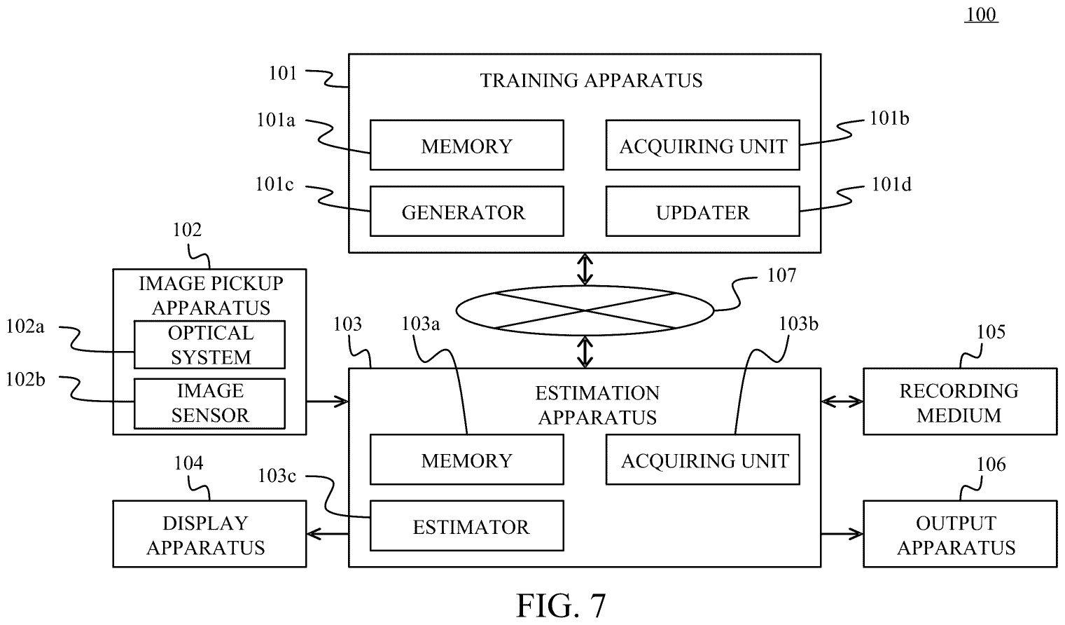

Referring now to FIG. 7, a description will be given of an image processing system 100 according to Example 1. FIG. 7 is a block diagram of the image processing system 100. The image processing system 100 includes a training apparatus (image processing apparatus) 101, an image pickup apparatus 102, an (image) estimation apparatus (image processing apparatus) 103, a display apparatus 104, a recording medium 105, an output apparatus 106, and a network 107. The training apparatus 101 includes a memory (storage unit) 101a, an acquiring unit 101b, a generator 101c, and an updater (training unit) 101d.

The image pickup apparatus 102 includes an optical system 102a and an image sensor 102b. The optical system 102a condenses light incident on the image pickup apparatus 102 from the object space. The image sensor 102b receives (photoelectrically converts) an optical image (object image) formed via the optical system 102a and acquires a captured image. The image sensor 102b is, for example, a Charge Coupled Device (CCD) sensor or a Complementary Metal-Oxide Semiconductor (CMOS) sensor. The captured image acquired by the image pickup apparatus 102 contains blurs due to aberrations and diffractions of the optical system 102a and noise due to the image sensor 102b.

The estimation apparatus 103 includes a memory 103a, an acquiring unit 103b, and an estimator 103c. The estimation apparatus 103 acquires the captured image and estimates a motion vector. A neural network is used to estimate the motion vector, and weight information (parameters) is read out from the memory 103a. The weights (weight information) are obtained by training using the training apparatus 101, and the estimation apparatus 103 reads the weight information from the memory 101a via the network 107 in advance and stores it in the memory 103a. The stored weight information may be a weight value itself or may be in an encoded format. Details regarding weight training and the motion vector estimation processing using the weights will be described later.

The estimated and output motion vector is output to at least one of the display apparatus 104, the recording medium 105, and the output apparatus 106. The display apparatus 104 is, for example, a liquid crystal display or a projector. The recording medium 105 is, for example, a semiconductor memory, a hard disk drive, a server on a network, etc. The output apparatus 106 is, for example, a printer. The estimation apparatus 103 has a function of performing other image processing, as necessary.

### Training Method

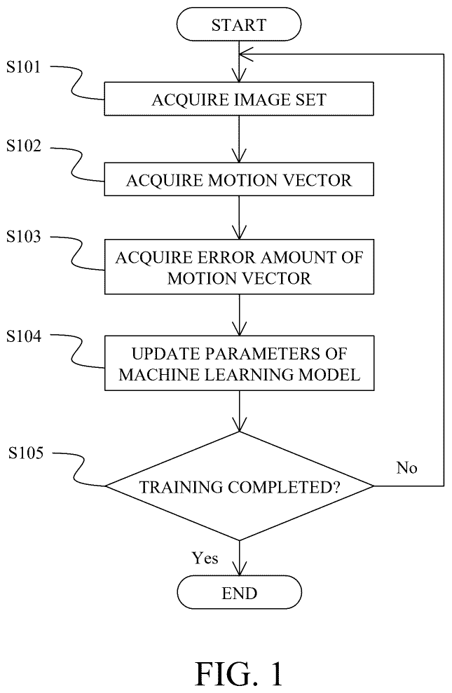

Referring now to FIG. 1, a description will be given of a training method of the motion vector estimation processing according to this example. FIG. 1 is a flowchart of the training method of the motion vector estimation processing. The flowchart in FIG. 1 can be embodied as a program that causes a computer to execute the functions of each step. This is similarly applicable to the following flowcharts. Each step in FIG. 1 is mainly executed by the acquiring unit 101b, the generator 101c, or the updater 101d of the training apparatus 101.

First, in step S101, the acquiring unit 101b acquires two consecutive images (frames) from a training data set of moving images as an image set including a plurality of images (first image and second image) that are used for training. The acquiring unit 101b also acquires data that is the ground truth data for the other image (second image) based on one image (first image), that is, the motion vector between the two images.

The image set may be acquired as the entire area of the image included in the training data set, or may be acquired as a partial area of the image. Here, an area of a predetermined size (third size) at the same image position of the two images is randomly cropped and acquired. A known data augmentation method, such as changing the luminance or color of the image set, may be used. Here, an area of 128×128 in size is obtained. The same area is also obtained for the ground truth data. In a case where cropping is not performed, the full pixel image size corresponds to the third size.

Next, in step S102, the generator 101c inputs the image set acquired in step S101 into a machine learning model and acquires an estimated motion vector. The machine learning model may be a known machine learning model such as a convolutional neural network. Here, the motion vector has the same resolution as that of the image.

Next, in step S103, the updater 101d calculates (acquires) an error (error amount) between the motion vector obtained in step S102 and the ground-truth motion vector obtained in step S101. The error can be calculated using an index such as, for example, absolute value error or L2 norm, but is not limited to it.

Next, in step S104, the updater 101d updates the parameters of the machine learning model by backpropagating the error acquired in step S103.

Next, in step S105, the updater 101d determines whether to end the training of the machine learning model. For example, it may be determined that the training is to be ended in a case where the number of updates exceeds a predetermined number of updates or the error amount becomes lower than a reference value. In a case where the training is not to be ended, the flow returns to step S101, and the acquiring unit 101b acquires a new image set and a ground-truth motion vector, and repeats the flow. In a case where the training is to be ended, the training in this example is terminated and the parameters of the trained machine learning model are obtained.

This example has discussed an example of using a ground-truth motion vector, but in the case of unsupervised learning, a ground-truth motion vector is not to be acquired in step S101. As the error in step S103, a geometric transformation based on the estimated motion vector may be applied to one of the two images (e.g., the second image), and a difference from the other image (e.g., the first image) may be evaluated. The evaluation index can use, for example, the L1 norm.

The image set acquired in step S101 may be acquired for a plurality of scenes. In that case, in step S102, a motion vector is estimated for each of a plurality of scenes, and in step S103, an error is calculated. The error (acquired error amount) calculated in step S103 uses the sum or average of each scene. Alternatively, three or more consecutive images may be acquired and a motion vector may be estimated between the adjacent images. In that case, similar processing may be performed for each pair of adjacent images.

### Estimation Method

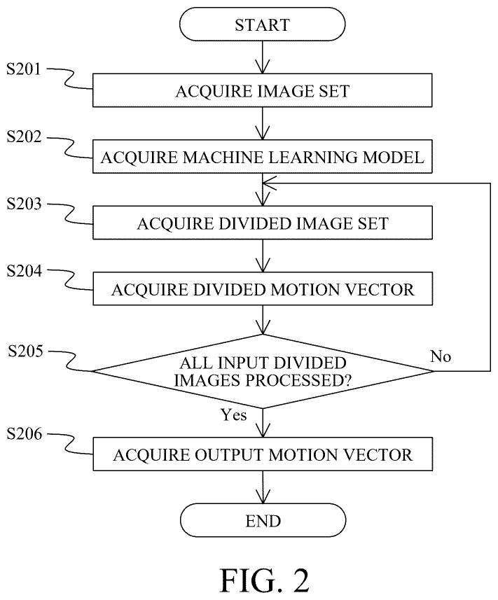

Referring now to FIG. 2, a description will be given of motion vector estimation processing using the machine learning model trained by the training method described with reference to FIG. 1. FIG. 2 is a flowchart of the motion vector estimation processing. Each step in FIG. 2 is mainly executed by the acquiring unit 103b or the estimator 103c in the estimation apparatus 103.

First, in step S201, the acquiring unit 103b acquires a plurality of images for estimating a motion vector as an input image set (first image set). In this example, the size (first size) of the input image set is 4K resolution (3840×2160), but is not limited to it. The 4K moving image is decoded to acquire two adjacent images (frames), a first image and a second image.

Next, in step S202, the acquiring unit 103b acquires a machine learning model trained by the training method described with reference to FIG. 1. The machine learning model in this example includes processing by a neural network.

Next, in step S203, the acquiring unit 103b acquires one input divided image set (second image set) to be input into the machine learning model from a plurality of divided areas (a plurality of partial areas) that divide (partition) the input image set.

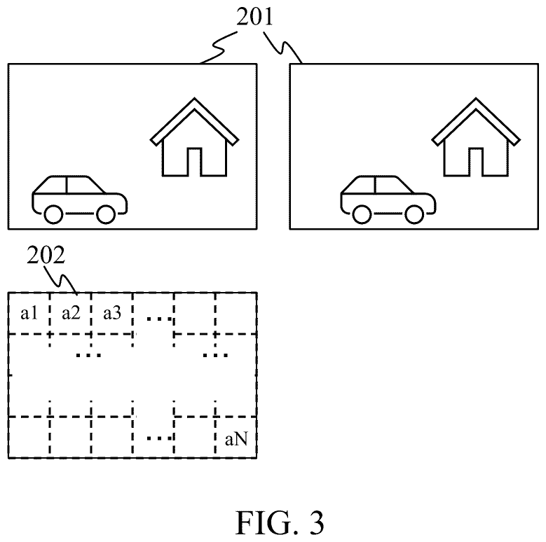

Referring now to FIG. 3, a detailed description will be given of a method of acquiring the input divided image set. FIG. 3 illustrates a relationship between the input image set and the plurality of divided areas, and reference numeral 201 denotes an input image set (first image set). Reference numeral 202 denotes a divided position at which the input image set is divided into blocks, expressed by dashed lines, and each of the plurality of partial areas surrounded by the dashed lines corresponds to an acquired area in acquiring a divided image. The divided position and divided size are set as predetermined values, and the input image set is divided into partial areas a1 to aN.

The plurality of images (first image and second image) included in the input image set are each divided at the same position, and the same partial area is obtained to form a divided image set (second image set). Since the machine learning model performs processing by inputting in block units, one partial area out of the partial areas al to aN is obtained in step S203. The partial areas may be set overlapping.

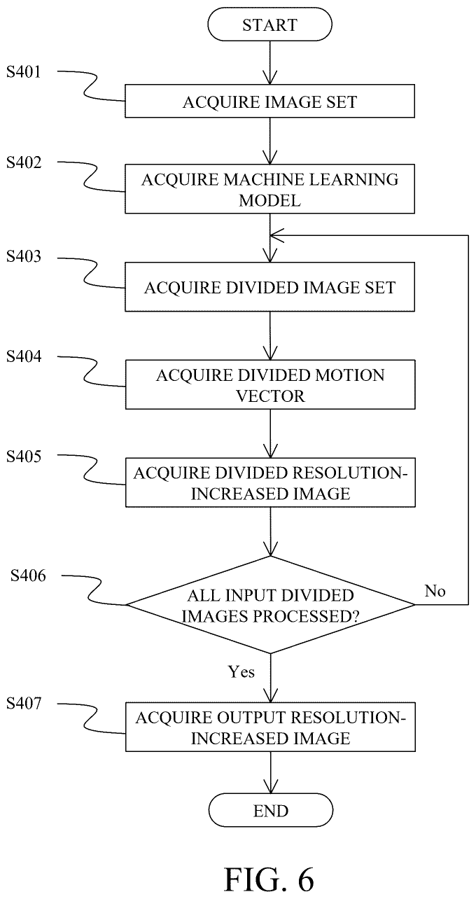

As the division size increases relative to the image size of 128×128 during training, the estimation accuracy of the motion vector lowers. Therefore, this example sets the division size to 128×128, which is the same as the image size during training. However, the division size may be different from the image size during training. In FIG. 6, a step of determining the second size based on at least one of the first size, the fourth size, and the machine learning model may be further included.

Next, in step S204, the estimator 103c inputs the divided image set of a predetermined size (second size) acquired in step S203 into the machine learning model acquired in step S202. The estimator 103c then estimates a motion vector (divided motion vector) corresponding to the divided image set. The divided motion vector is a map of the 128×128 image size, the same as each image in the divided image set, and has two channels, a horizontal component and a vertical component.

Next, in step S205, the estimator 103c determines whether or not all of the partial areas (input divided images) in the divided image set have been processed. In a case where it is determined that the processing of the partial areas has not yet been completed, the flow returns to step S203, where the unprocessed partial areas are acquired as a divided image set, and steps S203 and S204 are executed for the acquired divided image set. In a case where it is determined that the processing of all partial areas has been completed, the flow proceeds to step S206.

In step S206, the acquiring unit 103b acquires an output motion vector of the 3840×2160 size by arranging and concatenating the plurality of divided motion vectors as partial data so that they are in the same positional relationship as that before the division. Instead of the divided motion vectors, this example may acquire, as partial data, images that have been acquired based on the second image set and the divided motion vectors. The acquiring unit 103b then concatenates the plurality of partial data corresponding to the different partial areas. In a case where the divided areas overlap each other, they may be cut out so as not to overlap each other, or the overlap portions may be concatenated by taking a weighted average. Thereby, the image processing according to this example is completed.

In this example, the division size (second size) in step S203 does not have to be 128×128, and may be, for example, 192×192 (i.e., 1.5 times 128) or 160×160 (i.e., 1.25 times 128). In a case where the image size during estimation is equal to or smaller than the image size during training, highly accurate estimation based on training is possible. However, the accuracy of the estimated motion vector gradually decreases as the image size during estimation increases.

The inventors have found that there is a reference (criterion) image size (fourth size) for the image size during estimation that can be estimated with high accuracy by examining various variations (combinations) of the image size during training (first size) and the division size during estimation (second size). Here, the fourth size is a reference image size regarding the third size, which is the image size during training. In FIG. 2 or FIG. 6 (described later), a step of acquiring the fourth size may be further included.

The decrease in estimation accuracy can be suppressed by setting the image size (second size) input into the trained machine learning model during estimation, to be equal to or smaller than the reference image size (fourth size). The reference image size also depends on the size of the motion vector of the scene. Thus, the reference image size may be changed according to the image size during training (third size) and the size of the motion vector.

The reference image size (fourth size) may be equal to or smaller than 1.5 times the image size during training (third size). This configuration can estimate the motion vector with high accuracy. The reference image size may be 1.25 times or less the image size during training. This configuration can estimate the motion vector with high accuracy. The reference image size may be 1 times or less the image size during training. This configuration can estimate the motion vector with high accuracy.

The image size is not the total number of pixels of the image, but the number of horizontal or vertical pixels (the number of pixels on one side) is important. In a case where the pixel range referred to by the machine learning model becomes larger than the image size during training, the estimation accuracy decreases. Thus, each of the number of horizontal pixels and the number of vertical pixels (the number of pixels on one side) as the division size may be equal to or less than the reference image size. The number of pixels on one side is not limited to the number of pixels in the horizontal or vertical direction, and may be the number of pixels in the diagonal direction.

In a case where training is performed sequentially using a plurality of different datasets, such as advance learning, transfer learning, or fine tuning, at least one dataset may satisfy the above criterion for image size. All datasets may satisfy the above criterion for image size. To estimate a motion vector with high accuracy, the machine learning model may be trained so that its parameters are determined mainly by a dataset that meets the criterion. For example, in a case where training with a training dataset that does not meet the criterion follows sufficient training with a dataset that meets the criterion, the number of fine-tuning steps may be limited.

In the case of a multitask machine learning model, the weights that are used to estimate a motion vector trained with a dataset that meets the criterion may be fixed, and training of other tasks with a dataset that does not meet the criterion may be performed. An advance learning model that has been trained with images smaller than the criterion may thoroughly retrained with a dataset that meets the criterion.

In a model configuration that performs division and reduction within a machine learning model, even if only a part of the configuration meets the criterion, the estimation accuracy decreases due to the inclusion of a part that does not meet the criterion. Therefore, the image size during estimation may be equal to or smaller than the criterion relative to the image size during training for the entire configuration that affects the final estimated motion vector. In this case, rule-based processing such as average pooling and bilinear interpolation is not relevant to the present disclosure, and the size criterion may be met for processing using parameters determined by training.

After the image is divided into 256×256 areas in step S203, the image (second size image) reduced to 128×128 (reduced number of pixels) may be input into the machine learning model as a divided image set. The reduction processing lowers the estimation accuracy of details. Accordingly, this example that estimates a motion vector with high accuracy even for resolution-improved images has the division processing, and may reduce the image by about half.

In this example, the size (first size) of the input image set acquired in step S201 may be larger than the reference size (fourth size). In a case where the input image set is larger than the size (second size) input into the machine learning model, the estimation accuracy can be improved by acquiring the divided image set using the processing according to this example. In particular, in a case where the input image set is larger than the fourth size, the estimation accuracy decrease becomes significant, so the estimation accuracy can be greatly improved by acquiring the divided image set using the processing according to this example.

In this example, it may be determined whether or not to acquire a divided image set based on the size (first size) of the input image set and the reference size (fourth size). In a case where the input image set is larger than the reference size, a divided image set is acquired and input into the machine learning model. On the other hand, in a case where the input image set is equal to or smaller than the reference size, the input image set is input into the machine learning model as it is. Thereby, optimal processing can be performed according to the size of the input image set. In a case where the input image set is equal to or smaller than the reference size, the input image set is directly input into the machine learning model, and the time required for the dividing processing can be reduced.

In this example, the divided image set (second image set) input into the machine learning model may be an image set in which a partial area of the input image set is reduced. As described above, the image set reduced after division may be the divided image set, or the image set divided after reduction may be the divided image set.

The estimation processing according to this example may acquire the image size during training (third size). For example, acquiring the image size during training at the same time as acquiring the machine learning model in step S202 can determine the reference size based on the image size during training.

In this example, the image size (second size) of the divided image set may be determined based on at least one of the size of the input image set, the image size during training, and the machine learning model. The image size of the divided image set does not need to be fixed to a predetermined value. The image size of the divided image set is set to a size that allows the input image set to be divided efficiently based on overlapping of the divided images, and thereby the time required for the estimation processing can be reduced. In a case where the image size during training is acquired in association with a machine learning model, the image size of the divided image set may be determined based on the image size during training.

In a case where the machine learning model for the estimation processing is selected from a plurality of models, the image size during training may differ for each model, so the second size may be determined based on the model. By acquiring the model and the image size during training in association with each other, the motion vector can be estimated with high accuracy according to the selected model.

In this example, the machine learning model may be a convolutional neural network. An image larger than the image size during training can be input into the convolutional neural network. Applying this example to the convolutional neural network can estimate the motion vector with high accuracy for an input image set of an arbitrary image size.

In this example, the receptive field of the machine learning model may be larger than the second size. A large receptive field can estimate a motion vector with high accuracy based on the entire area of the divided image set. In a case where the image size of the divided image set is larger than the reference size, the estimation accuracy due to the problem of this example also decreases in a wide area but applying this example can estimate the motion vector based on a wide area of the input image using a highly accurate estimation.

In this example, a motion vector corresponds to a position shift amount of another image (second image) from one image (first image) included in the image set. In a case where the reference image is changed, the value of the motion vector changes. Therefore, the motion vector may be estimated based on one reference image, or the motion vector may be estimated based on each of a plurality of reference images. For example, for two images included in an image set, both the motion vector of one image based on the other image and the motion vector of one image based on the other image may be estimated.

### Example 2

Next, Example 2 according to the present disclosure will be described. Example 1 has discussed the estimation processing of an optical flow in a moving image. The estimated optical flow may be used for other image processing tasks. This example will discuss the resolution improvement processing of a moving image based on an estimated optical flow. The image processing according to this example is performed by an image processing system having the same configuration as the image processing system 100 described in Example 1 with reference to FIG. 1.

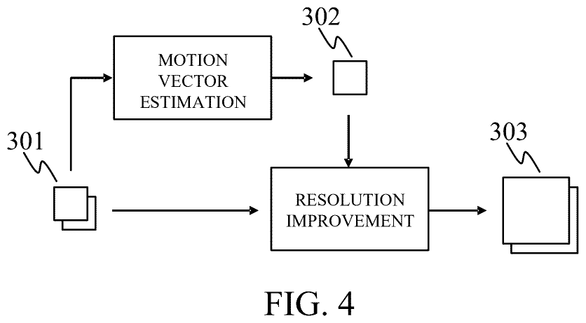

Referring now to FIG. 4, a description will be given of an overview of the image processing according to this example. FIG. 4 explains the image processing according to this example. An image set 301 is an image set input into a machine learning model and corresponds to a divided image set in Example 1. The motion vector estimation processing is performed using the machine learning model, as in Example 1. The image set 301 is input into a motion vector estimation model and a motion vector 302 in an area corresponding to the image set 301 is acquired. In addition, the resolution improvement processing of the image set 301 is performed using a machine learning model different from the motion vector estimation. The image set 301 and the motion vector 302 are input into the resolution improvement model, and a resolution-improved image set 303 corresponding to the image set 301 is output.

In the resolution improvement processing of a moving image, the same object is located at different positions in the images at different times, so the images are sampled differently during imaging. Therefore, using a plurality of images at different times can provide the resolution improvement processing with higher accuracy than that of the resolution improvement processing using a single image. Since the same object is located at different positions within the images, the highly accurate resolution improvement processing can be achieved by using the motion vector based on the difference in position.

To train a machine learning model that performs the resolution improvement processing based on a plurality of images, a ground truth resolution-improved image is used for an image set including a plurality of images. For example, a frame at a certain time in a moving image can be used as the ground truth resolution-improved data, and an image at the same time and an image at an adjacent time that have been reduced at a predetermined magnification can be input into the machine learning model as an image set. The image set is input into a machine learning model such as a neural network to estimate a resolution-improved image, and the parameters of the machine learning model are properly determined (or optimized) so as to reduce a difference from the ground truth resolution-improved image.

### Training Method

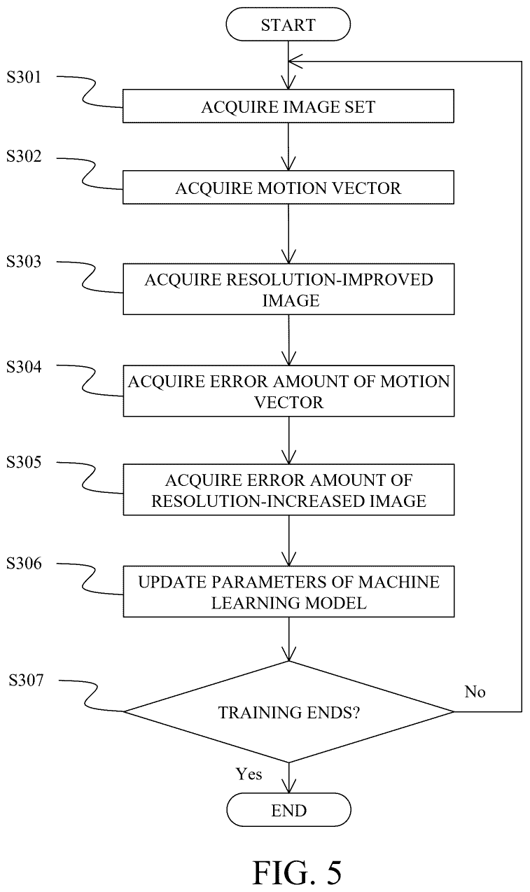

Referring now to FIG. 5, a description will be given of a training method of the resolution improvement processing according to this example. FIG. 5 is a flowchart of the training method of the resolution improvement processing. Each step in FIG. 5 is mainly executed by the acquiring unit 101b, the generator 101c, or the updater 101d in the training apparatus 101.

First, in step S301, the acquiring unit 101b acquires a ground truth resolution-improved image in addition to an image (image set) acquired in step S101. The ground-truth resolution-improved image has a 256×256 size for an image set of a 128×128 size. That is, this example sets the magnification of the resolution improvement processing to 2, but is not limited to this implementation. The subsequent step S302 is similar to step S102.

Next, in step S303, the generator 101c acquires a resolution-improved image based on the image set and the motion vector. The resolution-improved image is acquired by concatenating the image set and the motion vector and inputting the concatenated image into a machine learning model for resolution improvement. The machine learning model is not limited to a configuration that concatenates the image set and the motion vector. For example, any machine learning model that performs resolution improvement processing based on a motion vector, such as a configuration that inputs an image set in which a position shift is compensated using a motion vector, may be used. The following step S304 is similar to step S103.

Next, in step S305, the updater 101d calculates (acquires) an error (error amount of the resolution-improved image) between the resolution-improved image obtained in step S303 and the ground-truth resolution-improved image acquired in step S301, as in step S304.

Next, in step S306, the updater 101d updates the parameters of the machine learning model for motion vector estimation and the machine learning model for resolution improvement by backpropagating the error acquired in steps S303 and S304. The error of the motion vector may be used for backpropagation to the machine learning model for resolution improvement, or the error of the resolution-improved image may be used for backpropagation to the machine learning model for motion vector estimation.

Next, in step S307, the updater 101d determines whether or not to end the training of the machine learning model. For example, it may be determined that the training is to be ended in a case where the number of updates exceeds the predetermined number of updates or an error amount is lower than a reference value. In a case where the training is not to be ended, the flow returns to step S301, and a new image set, a ground-truth motion vector, and a ground-truth resolution-improved image are acquired, and the flow is repeated. In a case where the training is to be ended, the training of this example is ended, and the parameters of the machine learning model for estimating the trained motion vector and the machine learning model for resolution improvement are obtained.

This example has discussed an example in which a machine learning model for motion vector estimation and a machine learning model for resolution improvement are simultaneously trained, but is not limited to this implementation. The machine learning model for motion vector estimation and the machine learning model for resolution improvement may be trained separately. Alternatively, only the training of motion vector estimation may be performed first, and the parameters of the machine learning model for motion vector estimation may be fixed before training of the machine learning model for resolution improvement. Alternatively, the two machine learning models may be trained again at the same time using models that have been trained separately.

This example has discussed an example that uses a motion vector for resolution improvement, but the motion vector may also be used for processing of increasing a frame rate or sharpening processing using a plurality of images. The number of images in the image set may be more than two. The machine learning model for resolution improvement may output a plurality of resolution-improved images corresponding to frames at a plurality of different times.

### Estimation Method

Referring now to FIG. 6, a description will be given of the resolution improvement processing using a machine learning model trained by the training method described with reference to FIG. 5. FIG. 6 is a flowchart of the resolution improvement processing. Each step in FIG. 6 is mainly executed by the acquiring unit 103b or the estimator 103c in the estimation apparatus 103.

Step S401 is similar to step S201. However, the input image set (first image set) is used not only to estimate the motion vector but also to estimate the resolution-improved image.

Next, in step S402, the acquiring unit 103b acquires a machine learning model trained by the training method described with reference to FIG. 5. As the machine learning model, a model for estimating the motion vector and a model for resolution improvement are acquired. Next, step S403 is similar to step S203.

Next, in step S404, the estimator 103c inputs the divided image set of a predetermined size (second size) acquired in step S403 into the machine learning model for motion vector estimation acquired in step S402. The estimator 103c estimates a motion vector (divided motion vector) corresponding to the divided image set. The divided motion vector is a map of the same image size, 128×128, as that of each image in the divided image set, and has two channels, a horizontal component and a vertical component.

Next, in step S405, the estimator 103c inputs the divided image set acquired in step S403 and the divided motion vector acquired in step S404 into a machine learning model for resolution improvement. The estimator 103c then estimates a resolution-improved image (divided resolution-improved image) corresponding to the divided image set. The divided resolution-improved image corresponds to the same area as each image in the divided image set, but its resolution is improved to a size of 256×256. The following step S406 is similar to step S205.

In step S407, the acquiring unit 103b acquires an output resolution-improved image with 8K resolution (7680×4320) by arranging and concatenating a plurality of divided resolution-improved images as partial data so that they are in the pre-division positional relationship. In a case where the divided areas overlap each other, they may be cut out so as not to overlap each other, or the overlapping portions may be concatenated by taking a weighted average. Thereby, the image processing according to this example is completed.

Similarly to Example 1, the division size (second size) in step S403 does not have to be 128×128, and may be, for example, 192×192 (i.e., 1.5 times 128) or 160×160 (i.e., 1.25 times 128).

This example commonly uses the divided image set as an input into the machine learning model for motion vector estimation and the machine learning model for resolution improvement. In this case, the input size to each machine learning model does not have to be the same. For example, the input image set may be divided into images of a 256×256 size, and then an image set reduced to a 128×128 size may be input as the divided image set to the machine learning model for motion vector estimation.

The image set of a 256×256 size before reduction may be input into the machine learning model for resolution improvement. In this case, the size (second size) input into the machine learning model for motion vector estimation is the same as that of this example. As described above, the problem of the estimation accuracy decreasing as the image size during estimation increases relative to the image size during training does not occur in the resolution improvement processing. Therefore, in this variation, the motion vector that is used for the resolution improvement can be estimated with high accuracy.

Next, Examples 3 to 5 according to the present disclosure will be described. Before Examples 3 to 5 are more specifically described, matters common to Examples 3 to 5 will be described.

In each example, “size” refers to the number of pixels in the width and height of an image or map, and a “motion vector” is a vector that represents the movement of corresponding pixels between an image pair (two frame images).

First, the problem solved by each example will be described. In a machine learning model that generates a motion vector within the image pair based on the image pair, the size of the image pair is limited based on the image size trained by the machine learning model. More specifically, in a case where a motion vector is generated based on an image pair with a size larger than a threshold value times the trained image size, the accuracy of the motion vector (optical flow) is significantly impaired. The threshold value has a value equal to or more than 1 and less than 2, although it varies depending on the model structure of the machine learning model and a moving amount of the object contained in the image pair. For example, in a case where an image pair with 256×256 pixels is input into a machine learning model that has been trained to generate a motion vector by inputting an image pair with 128×128 pixels, the accuracy of the generated motion vector is significantly impaired.

The reason for this will now be described. The machine learning model that performs the task of generating a motion vector is trained to generate a motion vector for each pixel of the image pair based on a wider range of peripheral pixels, different from the machine learning model that performs the above image correcting task. In particular, a machine learning model with a wide receptive field may consider an area larger than the image size during training. In such cases, for example, the machine learning model is retrained with that area by filling the peripheral area of the image pair with pixel values of 0 or by mirroring the image pair.

On the other hand, in a case where a motion vector is generated based on an image pair that is larger than the trained image size, the area treated as a peripheral area during training also contains significant image data. Therefore, the machine learning model generates a motion vector based on the area. However, the machine learning model cannot properly use the significant image data that has not been trained to generate a motion vector, and the accuracy of the generated motion vector is significantly impaired.

Hence, in a machine learning model that generates a motion vector based on an image pair, the size of the image pair is limited based on the image size trained by the machine learning model. Accordingly, the image size in the machine learning task that uses a motion vector generated by a machine learning model is similarly limited based on the image size with which the machine learning model was trained.

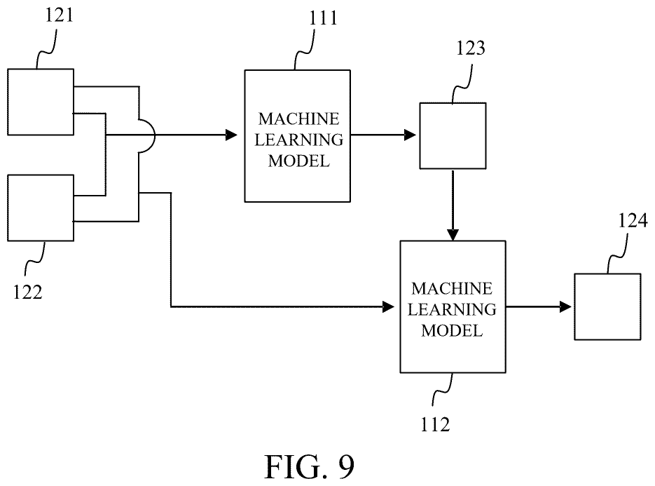

FIG. 9 illustrates the conventional processing for executing a machine learning task using a motion vector generated by a machine learning model. FIG. 9 illustrates the simplest conventional processing for generating an image 124 as an output from images 121 and 122, which are an image pair. In this conventional processing, the images 121 and 122 are first input into a machine learning model 111, and a motion vector 123 between the images 121 and 122 is generated. Next, the images 121 and 122, and motion vector 123 are input into a machine learning model 112, and the image 124 is generated. For example, in the case where the machine learning model 112 generates the image 124 from the images 121 and 122, each of which has 256×256 pixels, the machine learning model 111 also needs to input the images 121 and 122, each of which has 256×256 pixels, to generate the motion vector 123.

On the other hand, in a case where the machine learning model 111 is trained to generate a motion vector by inputting an image pair of 128×128 pixels, the accuracy of the generated motion vector 123 is significantly impaired. As a result, the machine learning model 112 cannot generate the image 124 with high accuracy.

Examples 3 to 5 illustrate a method for solving the above problem and for executing a machine learning task using a motion vector generated by a machine learning model with high accuracy without being limited based on the image size with which the machine learning model has been trained to generate the motion vector. More specifically, a first motion vector is generated using a first machine learning model based on a third image and a fourth image, which are obtained by reducing the first image and the second image, respectively.

Examples 3 to 5 generate a fifth image using a second machine learning model based on a second motion vector obtained by enlarging the first motion vector, the first image, and the second image. Here, the first image and the second image are both images of the same third size, and the third image and the fourth image are both images of the same first size. The first machine learning model can generate the first motion vector with high accuracy with a first size limited based on the image size trained by the first machine learning model. On the other hand, the second machine learning model can generate the fifth image with high accuracy with a third size that is not limited based on the image size trained by the first machine learning model.

Details of Examples 3 to 5 will be described below. The first image and the second image are first reduced to generate a third image corresponding to the first image and a fourth image corresponding to the second image. The first image and the second image are an image pair in which at least a part of the same object is included at different positions. The first image and the second image may be images extracted from the same moving image.

The reduction from the first image to the third image and the reduction from the second image to the fourth image are performed using the same reduction processing that converts from an image to an image. The reduction processing is, for example, downsampling that extracts only one pixel from a plurality of pixels, or binning that generates a pixel value of a new pixel using a plurality of pixels.

Next, Examples 3 to 5 generate a first motion vector based on the third image and the fourth image using a first machine learning model. Here, the first motion vector is a vector that represents the movement of corresponding pixels between the third image and the fourth image. For example, the first motion vector is a vector that indicates the movement from the fourth image to the third image for each pixel in the third image. The first motion vector may be generated by inputting the third image and the fourth image into the first machine learning model.

The first machine learning model is, for example, a convolutional neural network (CNN). However, the first machine learning model may be trained to generate a motion vector based on a first training image set consisting of a plurality of images having a second size. The second size may be equal to or larger than the first size (the size of the third image and the fourth image). As described above, in a case where a motion vector is generated based on an image pair whose size is larger than the threshold value times the second size, the accuracy of the generated motion vector is significantly impaired. The threshold value has a value in a range equal to or more than 1 and less than 2, although it varies depending on the model structure of the first machine learning model and a moving amount of the object included in the image pair. Due to the first size equal to or smaller than the second size (i.e., the second size equal to or larger than the first size), the first machine learning model can generate a highly accurate first motion vector regardless of the first machine learning model itself or the third and fourth images.

Next, Examples 3 to 5 enlarge the first motion vector by the enlargement processing to generate a second motion vector. The enlargement processing in each example is processing independent of the first machine learning model. This enlargement processing may be enlargement processing using a machine learning model as long as it is independent of the first machine learning model, or may be enlargement processing using no machine learning model. The enlargement processing using the machine learning model is, for example, processing that uses one or more deconvolution layers or subpixel convolution processing. The subpixel convolution processing is processing that performs enlargement by rearranging pixels after a convolution operation. The enlargement processing uses weights that are not trained based on the first machine learning model. The enlargement processing that uses no machine learning model uses a known interpolation method such as nearest neighbor interpolation, bilinear interpolation, or bicubic interpolation. An enlargement ratio in this enlargement processing may be the same as a reduction ratio in the reduction processing that reduces the first image and the second image to the third image and the fourth image, respectively. The second motion vector may have a third size that is the same as that of each of the first image and the second image.

Finally, Examples 3 to 5 generate a fifth image based on the first image, the second image, and the second motion vector using the second machine learning model. The second machine learning model is, for example, a CNN. The fifth image may be generated by inputting the first image, the second image, and the second motion vector into a second machine learning model. The fifth image may be generated by processing the first image, the second image, or the second motion vector, and then inputting the processed image into the second machine learning model. For example, the fifth image may be generated by previously enlarging the first image and the second image using interpolation processing or the like, and then inputting the enlarged first image, the enlarged second image, and the second motion vector into the second machine learning model.

The second machine learning model may be trained to generate images based on a second training image set consisting of a plurality of images having a fourth size. The third size (the size of the first image and the second image) may be equal to or larger than the fourth size (i.e., the fourth size is equal to or smaller than the third size).

The effects obtained by the processing of Examples 3 to 5 will be described in comparison with the conventional processing illustrated in FIG. 9. As described above, the conventional processing of FIG. 9 is the simplest processing for generating the image 124 from the images 121 and 122. In order to generate the image 124 with high accuracy using the conventional processing, the image size of images 121 and 122 (corresponding to the third size) is limited based on the image size that is used by the machine learning model 111 for training (corresponding to the second size). In the conventional processing, since the training of the machine learning model 112 is also performed in the flow illustrated in FIG. 9, the image size that is used by the machine learning model 112 for training (corresponding to the fourth size) is similarly limited based on the image size that is used by the machine learning model 111 for training (corresponding to the second size). Regardless of the machine learning model 112 itself or the image that is used by the machine learning model 112 for training, the fourth size is ideally limited to be equal to or smaller than the second size in order to effectively train the machine learning model 112.

On the other hand, the image size that is used by the machine learning model 112 for training may be as large as possible. This is because as the image size increases, the machine learning model 112 can generate a highly accurate image 124 for the larger size of the images 121 and 122. Thus, the fourth size is set equal to the second size. For the above reasons, in the conventional processing, the image size of the images 121 and 122 (corresponding to the third size) is limited based on the image size (corresponding to the fourth size) trained by the machine learning model 112.

In each example, the second machine learning model may be trained in the same manner as that of the conventional processing. That is, the second machine learning model may be trained to generate a new image based on an image pair and a motion vector generated by inputting the image pair into the first machine learning model. At this time, the size of the image pair that is used by the second machine learning model for training (fourth size) is limited to the second size trained by the first machine learning model as in the conventional processing, and is set equal to the second size for the same reason as in the conventional processing.

On the other hand, in Examples 3 to 5, the size of the first image and the second image (third size) is not limited based on the second size as described above. The third size is not limited by the fourth size that is equal to the second size. The third size may be equal to or larger than the fourth size. Even if the fourth size is limited by the computational resources during training, the third size to be equal to or larger than the fourth size can set an optimal third size for the second machine learning model or the processing before and after the task executed by the second machine learning model. That is, the degree of freedom of the third size is improved. Details of this will be explained in Example 3.

In Examples 3 to 5 described below, a stage for determining the weights of the machine learning model is called a training phase. A stage of generating the fifth image from the first image and the second image using the first machine learning model and the second machine learning model and the weights determined by training is called an estimation phase. The machine learning model includes a neural network, genetic programming, a Bayesian network, etc. The neural network includes a Convolutional Neural Network (CNN), a Generative Adversarial Network (GAN), a Recurrent Neural Network (RNN), etc.

### Example 3

Example 3 improves the resolution of a moving image. Example 3 improves the resolution of a plurality of low-resolution frame images included in a low-resolution moving image, and generates a high-resolution moving image by combining the high-resolution frame images. Thus, this example generates a third image and a fourth image by reducing a first image as at least a part of a low-resolution frame image, and a second image as at least a part of a low-resolution frame image adjacent to the frame image, respectively. In addition, this example generates a first motion vector using a first machine learning model based on the third image and the fourth image. Furthermore, this example generates a fifth image corresponding to the first image and having a resolution higher than that of the first image using a second machine learning model based on the first image, the second image, and the second motion vector generated by enlarging the first image. The fifth image is at least a part of a high-resolution frame image.

Example 3 generates a high-resolution moving image having twice as large as the size of the moving image in both the width direction and the height direction (i.e., totally four times) by increasing the resolution of the low-resolution original moving image. The generated high-resolution moving image has a sampling pitch twice as small as that of the original low-resolution moving image. The resolution improvement in this example is pixel increasing. The fifth image is an image obtained by upscaling the first image, and the size of the fifth image is larger than that of the first image. However, the resolution improvement is not limited to the pixel increasing. For example, the fifth image may be an image having the same size as that of the first image and obtained by removing noise, blur, shake, and the like from the first image.

This example generates the fifth image using the first image and the second image that is temporally adjacent. Thereby, the fifth image can be generated that has a resolution higher than that of the fifth image generated using only the first image. This provides the pixel-shift super-resolution effect that complements object information in a first image from frames adjacent in time. For example, in a case where an object in a first image is sampled while half a pixel is shifted in a third image, twice as much high frequency information about the object is obtained.

This example can provide the following effects. The first machine learning model can generate a first motion vector with high accuracy at the size (first size) of the third image and the fourth image limited based on the image size (second size) trained by the first machine learning model. In this example, by using the highly accurate, first motion vector, the second image can be accurately aligned inside the second machine learning model so that it becomes an image equivalent to the first image (so that each pixel of the second image is aligned with the position of the corresponding pixel of the first image). Hence, the object information in the second image can be aggregated with higher accuracy. This is particularly effective in a case where the receptive field of the second machine learning model is small. This example is effective for the size of the first and second images (third size) that is not limited based on the second size.

This example discusses an implementation that generates a fifth image by improving the resolution of the first image using the second image that is temporally adjacent to the first image in addition to the first image, but may use more images that are temporally adjacent to the first image. This can supplement information about an object that does not exist in the first image from more images, and generate a fifth image with a higher resolution.

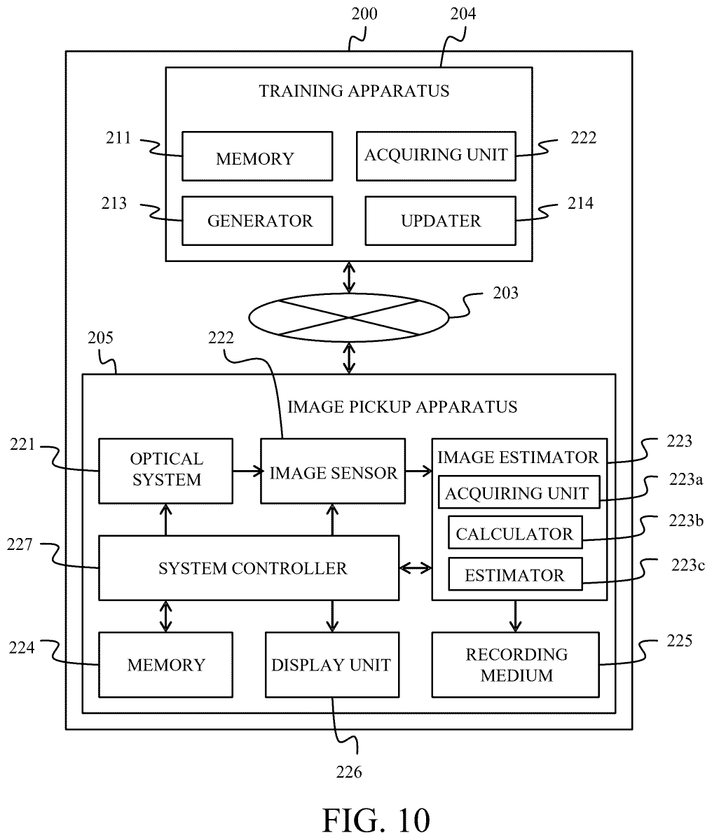

FIG. 10 illustrates the configuration of an image processing system 200 according to Example 3. FIG. 11 illustrates the overview of the image processing system 200. The image processing system 200 includes a training apparatus 204, an image pickup apparatus 205, and a network 203. The training apparatus 204 and the image pickup apparatus 205 are connected to each other via the wired or wireless network 203.

The training apparatus 204 includes a computer such as a personal computer, includes a memory 211, an acquiring unit 212, a generator 213, and an updater 214, and operates according to a program to determine the weights of the machine learning model.

The image pickup apparatus 205 includes an optical system 221, an image sensor 222, an image estimator 223 as an image processing apparatus, a memory 224, a recording medium 225, a display unit 226, and a system controller 227. The optical system 221 forms an object image by condensing light incident from the space in which an object exists. The optical system 221 has functions such as zoom, aperture stop, and autofocus as necessary. The image sensor 222 converts the object image formed by the optical system 221 into an electrical signal (i.e., captures an object image through the optical system 221) to generate a captured moving image as image data. The image sensor 222 includes a Charge Coupled Device (CCD) sensor, a Complementary Metal-Oxide Semiconductor (CMOS) sensor, or the like.

The image estimator 223 includes a computer such as a CPU or an MPU, and operates according to a program to increase the resolution of the captured moving image generated by the optical system 221 and the image sensor 222. A first motion vector is generated using a first machine learning model based on a third image and a fourth image obtained by reducing a first image and a second image, which are parts of frame images constituting the captured moving image. The image estimator 223 generates a fifth image using a second machine learning model based on a second motion vector obtained by enlarging the first motion vector, the first image, and the second image. The image estimator 223 generates a high-resolution moving image by increasing the resolution of the captured moving image using the fifth image. The weights of the machine learning model previously determined by the training apparatus 204 are used to generate the fifth image. The weights are stored in the memory 224. The image estimator 223 includes an acquiring unit 223a, a calculator 223b, and an estimator 223c. The processing performed by the image estimator 223 will be described in detail later.

The recording medium 225 records the high-resolution moving image. The display unit 226 displays the high-resolution moving image in a case where the user instructs to output the high-resolution moving image. The above operations are controlled by the system controller 227.

The processing performed in this example is classified into generating training data for the first machine learning model, training the weights for the first machine learning model (first training phase), generating training data for the second machine learning model, training the weights for the second machine learning model (second training phase), and estimation by the first machine learning model and the second machine learning model using the trained weights (estimation phase).

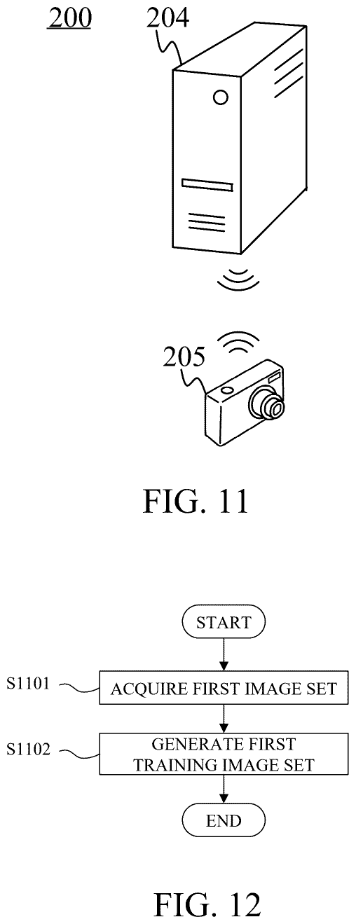

First, the processing of generating training data for the first machine learning model performed by the training apparatus 204 will be described using the flowchart of FIG. 12. In this example, the first machine learning model is trained by unsupervised learning that has no ground truth data. The training data is a first training image set and is used to train the first machine learning model. In the next first training phase, the first training image set is input into the first machine learning model.

In this example, the training apparatus 204 generates training data for the first machine learning model, but another device may generate the training data.

In step S1101, the acquiring unit 212 acquires the first image set from the memory 211. The first image set includes one or more first image pairs. One image of the first image pair includes at least a part of an object included in the other image of the first image pair, at a position different from that of the first image pair. Each image constituting the first image pair in the first image set may constitute a first image pair different from the other image included in the first image set. The first image set may include a captured image or a Computer Graphics (CG) image. For example, the first image set may include a plurality of frame images extracted from a captured moving image. The first image set may also be a public dataset such as a Realistic and Diverse Scenes (REDS) dataset.

The first image set may include images including various objects. For example, the first image set may include images including edges, textures, gradients, or flat parts having various intensities and directions. Thereby, the robustness of the first machine learning model can be improved against objects included in the third image and the fourth image.

The first image set may include images including image quality degradation of the third image and the fourth image. The image quality degradation includes, for example, jaggies, spatial aliasing, compression artifacts, and noise included in contours and edges. Thereby, the robustness of the first machine learning model can be improved against image quality degradation of the third image and the fourth image.

In addition, one image of the first image pair may be an image in which a plurality of objects included in the other image of the first image pair have moved with different moving amounts or different moving directions. That is, the two images in the first image pair may include a plurality of objects with different moving amounts or different moving directions. The plurality of first image pairs included in the first image set may also include different moving amounts or different moving directions of the objects. Thereby, the robustness of the first machine learning model can be improved against the movement between the third image and the fourth image.

Next, in step S1102, the generator 213 generates a first training image set. Then, this processing is completed. The first training image set includes one or more first training image pairs. The first training image pairs are pairs of images each having a predetermined size (second size), and in this example, the second size is 128×128 pixels. One image of the first training image pair includes at least a part of an object included in the other image of the first training image pair, at a position different from that of the other image.

This example generates the first training image pair by cropping an area having the second size at the same position from both images of the first image pair. However, the first training image pair may be generated by resizing at least a part of the first image pair to the second size. This example generates the first training image set from the first image set, but if the size of the first image set is the same as the second size, the processing of generating the first training image set from the first image set is unnecessary.

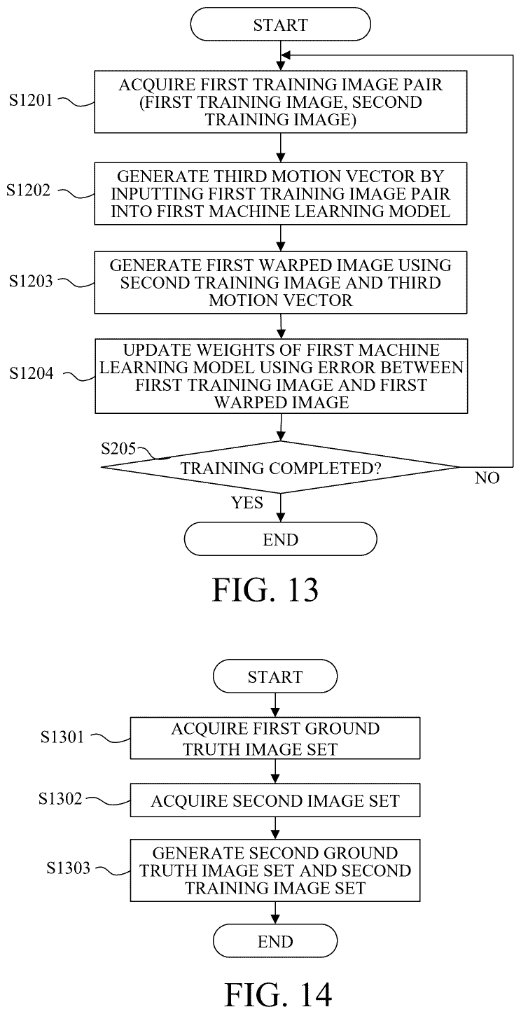

Next, the processing (training method) of training the weights of the first machine learning model performed by the training apparatus 204 as the first training phase will be described using a flowchart of FIG. 13. As described above, in this example, the first machine learning model is trained by unsupervised learning that has no ground truth data. Hereinafter, one image of the first training image pair will be referred to as a first training image, and the other image will be referred to as a second training image. In the first training phase, the training apparatus 204 first inputs the first training image pair included in the first training image set, which is the training data, into the first machine learning model, and acquires a third motion vector indicating the movement of corresponding pixels in the first training image pair.

Next, using the third motion vector, the training apparatus 204 generates an image (a first warped image described later) in which the second training image is aligned so that it becomes an image equivalent to the first training image (so that each pixel of the second training image approaches the corresponding pixel of the first training image). Then, the weights of the first machine learning model are determined so as to reduce a difference between the first training image and the first warped image. In other words, the first machine learning model is trained.

In step S1201, the acquiring unit 212 acquires one or more first training image pairs from the memory 211.

In step S1202, the generator 213 inputs the first training image pair into the first machine learning model and generates a third motion vector. The third motion vector is a vector that represents the movement of corresponding pixels within the first training image pair, i.e., between the first training image and the second training image. In this example, the third motion vector has the same size as that of the first training image pair, but the size of the third motion vector is not limited to this implementation. In this example, the third motion vector is a vector that indicates the movement from the second training image to the first training image for each image of the first training image. In this example, the third motion vector is two types of two-dimensional maps, each of which indicates a moving amount in the horizontal or vertical direction for each pixel position of the first training image.

In this example, the first machine learning model is a CNN having a plurality of convolution layers. In the first training, the weights (filter coefficients and biases) of the convolution layers are generated by random numbers. However, the first machine learning model is not limited to a CNN, and may be another machine learning model such as a GAN or an RNN.

Next, in step S1203, the generator 213 generates a first warped image using the second training image and a third motion vector. The first warped image is an image in which the second training image is aligned so that it becomes an image equivalent to the first training image by moving the pixels of the second training image using the third motion vector.

The generator 213 calculates each pixel value of the first warped image from the pixel values of the second training image using a known interpolation method (interpolation processing) such as the nearest neighbor interpolation, the bilinear interpolation, or the bicubic interpolation. In this case, the interpolation method that is used to calculate the pixel values of the first warped image may be the same as the interpolation method that is used to align the second image inside the second machine learning model so that it becomes an image equivalent to the first image in the estimation phase. Thereby, the first machine learning model can be trained so that the second machine learning model generates a fifth image with higher accuracy.

This example adopts the backward warping that aligns the second training image so that it becomes an image equivalent to the first training image using a third motion vector indicating the movement from the second training image to the first training image for each pixel in the first training image. This example may adopt the forward warping that aligns the first training image so that it becomes an image equivalent to the second training image using the third motion vector. This example uses the backward warping for the second machine learning model in the estimation phase, and thus uses the backward warping even for step S1203. In other words, the same alignment method as the alignment method adopted in the second machine learning model in the estimation phase may be adopted. Thereby, the first machine learning model can be trained so that the second machine learning model generates a fifth image with higher accuracy.

Next, in step S1204, the updater 214 updates (determines) the weights of the first machine learning model based on an error between the first training image and the first warped image. This example sets the Charbonnier loss of a pixel value difference between the first training image and the first warped image to the loss function. However, the loss function is not limited to this example. In a case where a plurality of pairs of first training images are obtained in step S1201, the updater 214 calculates a value of the loss function for each pair. Then, the updater 214 updates the weights using the backpropagation method or the like from the calculated value of the loss function.

Next, in step S1205, the updater 214 determines whether training of the first machine learning model is completed. The training completion can be determined, for example, by whether the number of iterations of updating the weights has reached a predetermined number, or whether a change amount in the weights during updating is smaller than a predetermined value. In a case where it is determined that the weight training has not been completed, the flow returns to step S1201, and the acquiring unit 212 acquires one or more new first training image pairs. In a case where it is determined that the weight training is completed, the updater 214 ends the training and stores the weight information in the memory 211.

In this example, the first machine learning model is trained by unsupervised learning, but the training method of the first machine learning model is not limited to this implementation. For example, the first machine learning model may be trained by supervised learning using ground truth data of the third motion vector corresponding to the first training image pair.

A flowchart in FIG. 14 illustrates the processing of generating training data for the second machine learning model, which is performed in the training apparatus 204. The training data is a second ground truth image set and a second training image set, and is used to train the second machine learning model. In the next second training phase, the weights of the second machine learning model are determined so as to reduce a difference between a sixth image obtained by inputting the second training image set into the second machine learning model and the second ground truth image set. In other words, the second machine learning model is trained.

In this example, the training apparatus 204 generates training data for the second machine learning model, but another device may generate it.

In step S1301, the acquiring unit 212 acquires a first ground truth image set from the memory 211. The first ground truth image set includes one or more first ground truth images. The first ground truth image set may include captured images or CG images. For example, the first ground truth image set may include frame images extracted from captured moving images. The first ground truth image set may also be a public dataset such as a REDS dataset.

The first ground truth image set may include images including various objects. For example, images including edges, textures, gradients, or flat parts having various intensities and directions may be included. Thereby, the robustness of the second machine learning model can be improved for objects included in the first image and the second image.

The first ground truth image may have a sufficient high-frequency component. For example, in a case where the first training image is a captured image, the first ground truth image may be an image captured by an optical system with higher performance than the optical system 221, or a frame image extracted from a moving image captured by the optical system. The first ground truth image may be an image obtained by reducing these captured images or frame images. Thereby, the second machine learning model can generate a fifth image that contains sufficient high-frequency components and has a high resolution.

Next, in step S1302, the acquiring unit 212 acquires a second image set from the memory 211. The second image set includes one or more second image pairs. The size of the second image pair is smaller than the size of the first ground truth image, and one image of the second image pair is an image including the same object as that of the first ground truth image. That is, one image of the second image pair contains the same object as that of the first ground truth image, and has a larger sampling pitch than that of the first ground truth image. A ratio of the size of the second image pair to the size of the first ground truth image is equal to a ratio of the size of the first image and the second image to the size of the fifth image in the estimation phase.

One image of the second image pair contains at least a part of the object included in the other image of the second image pair, at a position different from that of the other image. Each image constituting the second image pair in the second image set may constitute a second image pair different from the other image included in the second image set. The second image set may include a captured image or CG image. The second image set may include a plurality of frame images extracted from a captured moving image. The second image set may be a public dataset such as a REDS dataset.

The second image set may include images containing image quality degradation of the first image and the second image. The image quality degradation is similar to that of the third and fourth images described above. Thereby, the robustness of the second machine learning model can be improved against image quality degradation of the first and second images.

One image of the second image pair may be an image in which a plurality of objects included in the other image of the second image pair move with different moving amounts or moving directions. That is, each image in the second image pair may include a plurality of objects with different moving amounts or moving directions. The plurality of second image pairs included in the second image set may include different moving amounts or different moving directions of the objects. Thereby, the robustness of the second machine learning model can be improved against the movement between the first and second images.

The second image set may be generated using the first ground truth image set. For example, the second image set may be generated by downscaling the first ground truth image set and imparting the image quality degradation of the first and second images. Alternatively, different sets of images may be used to generate the first ground truth image set and the second image set, respectively.

Next, in step S1303, the generator 213 generates a second ground truth image set and a second training image set. Then, this processing is completed. The second ground truth image set includes one or more second ground truth images, and the second training image set includes one or more second training image pairs. The second ground truth image is an image having a predetermined size, which is 256×256 pixels in this example. The second training image pair is an image pair having a predetermined size (fourth size), which has 128×128 pixels in this example. The fourth size is smaller than the size of the second ground truth image. One image of the second training image pair is an image that includes the same object as that of the second ground truth image. That is, one image of the second training image pair is an image that includes the same object as that of the second ground truth image and has a larger sampling pitch than that of the second ground truth image. A ratio of the size of the second training image pair to the size of the second ground truth image is equal to a ratio of the size of the first image and the second image to the size of the fifth image in the estimation phase.

One image of the second training image pair includes at least a part of the object included in the other image of the second training image pair, at a position different from that of the other image. This example generates the second ground truth image by cropping an area having a predetermined size of the second ground truth image from the first ground truth image. The second training image pair is generated by cropping an area having a fourth size at the same position from both images of the second image pair. The second training image set may have at least a part in common with the first training image set that is used to train the first machine learning model.

This example generates the second ground truth image set from the first ground truth image set, but if the first ground truth image set is the same as the required image size, the processing of generating the second ground truth image set from the first ground truth image set is unnecessary. Although the second training image set is generated from the second image set, if the size of the second image set is the same as the required image size, the processing of generating the second training image set from the second image set is unnecessary.

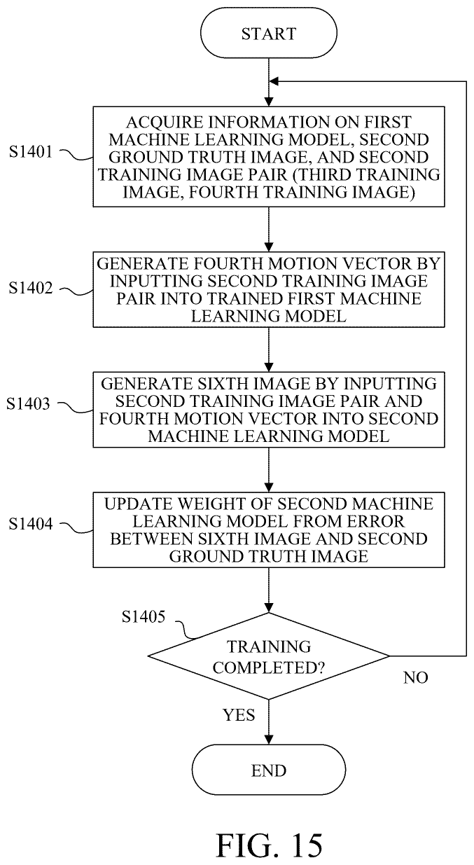

A flowchart in FIG. 15 illustrates the processing (training method) of training the weights of the second machine learning model performed in the training apparatus 204 as the second training phase. Hereinafter, one image of the second training image pair will be referred to as a third training image, and the other image will be referred to as a fourth training image. In this processing, the second training image pair included in the second training image set, which is the training data, is first input into the first machine learning model trained in the first training phase to obtain a fourth motion vector indicating the movement of corresponding pixels in the second training image pair. Next, in the second machine learning model, a sixth image is generated using the third training image, the fourth training image, and an image (a second warped image described later) in which the fourth training image is aligned using the fourth motion vector so that it becomes an image equivalent to the third training image. Finally, the weights of the second machine learning model are determined so as to reduce a difference between the sixth image and the second ground truth image.

In step S1401, the acquiring unit 212 acquires weight information on the first machine learning model, one or more second ground truth images, and one or more second training image pairs from the memory 211. The weight information on the first machine learning model is previously read out from the memory 211 and stored in the memory 224.

Next, in step S1402, the generator 213 inputs the second training image pair (the third training image and the fourth training image) into the trained first machine learning model to generate a fourth motion vector. The trained first machine learning model is the first machine learning model whose weights have been determined by training in the first training phase. The fourth motion vector is a vector representing the movement of corresponding pixels in the second training image pair, i.e., between the third training image and the fourth training image. In this example, the fourth motion vector has the same size as that of the second training image pair, but the size of the fourth motion vector is not limited to this implementation. In this example, the fourth motion vector is a vector indicating the movement from the fourth training image to the third training image for each image of the third training image. In this example, the fourth motion vector is two types of two-dimensional maps, and each two-dimensional map indicates a moving amount in the horizontal or vertical direction for each pixel position of the third training image.

Next, in step S1403, the generator 213 inputs the second training image pair and the fourth motion vector into the second machine learning model to generate a sixth image. At this time, the generator 213 first generates a second warped image using the fourth training image and the fourth motion vector inside the second machine learning model. The second warped image is an image in which the pixels of the fourth training image are moved using a fourth motion vector to align the fourth training image so that it becomes an image equivalent to the third training image. The generator 213 calculates each pixel value of the second warped image from the pixel values of the fourth training image using the known interpolation method such as the nearest neighbor interpolation, the bilinear interpolation, the bicubic interpolation, etc.

The interpolation method that is used to calculate pixel values of the second warped image may be the same as the interpolation method that is used to align the second image so that it becomes an image equivalent to the first image inside the second machine learning model in the estimation phase. Using the same image interpolation method in the second machine learning model between the second training phase and the estimation phase can train a second machine learning model that generates a fifth image with higher accuracy.

An image may be generated in which each pixel of the second warped image is more accurately aligned with the corresponding pixel of the third training image based on the second warped image inside the second machine learning model, and set as a new second warped image. For example, the third training image and the second warped image may be input into a CNN, a shift amount of each pixel of the second warped image from the corresponding pixel of the third training image may be calculated, and the second warped image may be further corrected according to the shift amount. Even in the estimation phase, if the second machine learning model performs similar processing, the second image can be more accurately aligned so that it becomes an image equivalent to the first image, and a fifth image can be generated with higher accuracy.

This example adopts the backward warping that aligns the fourth training image so that it becomes an image equivalent to the third training image using a fourth motion vector indicating the movement from the fourth training image to the third training image for each pixel of the third training image. Alternatively, forward warping may be performed to align the fourth training image so that it becomes an image equivalent to the third training image using a fourth motion vector indicating the movement from the third training image to the fourth training image for each pixel of the fourth training image. Since this example adopts the backward warping in the second machine learning model in the estimation phase, the backward warping is also adopted in S1403. Thus, using the same image alignment method in the second machine learning model between the second training phase and the estimation phase can train a second machine learning model that generates a fifth image with higher accuracy.

Next, the generator 213 generates a sixth image using the third training image and the second warped image inside the second machine learning model. The third training image and the second warped image are concatenated in the channel direction in a concatenation layer included in the second machine learning model. The sixth image is an image obtained by upscaling the third training image.

In this example, the second machine learning model is a CNN having a plurality of convolution layers. In the first training, the weights (filter coefficients and biases) of the convolution layer are generated by random numbers. The second machine learning model is not limited to the CNN, and may be another machine learning model such as a GAN or an RNN.

A contribution ratio of each of the third training image and the second warped image to the generation of the sixth image may be determined within the second machine learning model, and the sixth image may be generated according to the contribution ratio. This contribution ratio may be determined for each pixel of the third training image and the second warped image. For example, the third training image and the second warped image may be input into a CNN, and a contribution ratio of each pixel of the third training image and the second warped image to the generation of the sixth image may be determined. If the second machine learning model performs similar processing in the estimation phase, the contribution ratio of each of the first image and the second image can be adjusted, and a fifth image with higher accuracy can be generated.

This example generates the sixth image using the second warped image in which the fourth training image is aligned so that it becomes an image equivalent to the third training image. Alternatively, the sixth image may be generated through processing of aligning a feature amount of the fourth training image, rather than processing of aligning the fourth training image. More specifically, in the processing of generating the sixth image, for example, the feature amount of the fourth training image may be aligned so that it becomes a feature amount corresponding to the feature amount of the third training image using a fourth motion vector.

Next, in step S1404, the updater 214 updates the weights of the second machine learning model based on an error between the sixth image and the second ground truth image. This example sets a loss function to the Charbonieros of a difference in pixel values between the sixth image and the second ground truth image. However, the loss function is not limited to this example. In a case where a plurality of pairs of second training images are obtained in step S1401, the updater 214 calculates the value of the loss function for each pair. The updater 214 updates the weights using the backpropagation method or the like from the calculated value of the loss function.

Next, in step S1405, the updater 214 determines whether the training of the second machine learning model has been completed. The completion of training can be determined, for example, by whether the number of iterations of the weight update has reached a predetermined number, or whether a change amount in the weight during the update is smaller than a predetermined value. In a case where it is determined that the weight training has not been completed, the flow returns to step S1401, and the acquiring unit 212 acquires one or more new second training image pairs and a second ground truth image. In a case where it is determined that the weight training has been completed, the updater 214 ends the training and stores the weight information in the memory 211.

In this example, after the first machine learning model is trained in the first training phase, the second machine learning model is trained in the second training phase. This example is not limited to this implementation, and the first machine learning model and the second machine learning model may be jointly trained. More specifically, without performing the first training phase, the second training phase is performed using the first machine learning model for which weights have not been determined. Then, in step S1404, the weights of the first machine learning model and the weights of the second machine learning model may be updated simultaneously based on the error between the sixth image and the second ground truth image. The weights of the first machine learning model and the weights of the second machine learning model may be updated simultaneously based on the error between the sixth image and the second ground truth image and the error between the third training image and the second warped image. In the estimation phase, the first machine learning model and the second machine learning model are jointly used to generate the fifth image from the first image and the second image. Therefore, by jointly training the first machine learning model and the second machine learning model, the weights of the first machine learning model and the weights of the second machine learning model can be optimized so as to generate a fifth image with higher accuracy.

After the first and second training phases are performed, a third training phase for jointly updating the weights of the first and second machine learning models may be provided. Thereby, the weights of the first and second machine learning models can be properly determined (optimized) so as to generate a fifth image with higher accuracy, and the training of each machine learning model can be easily converged.

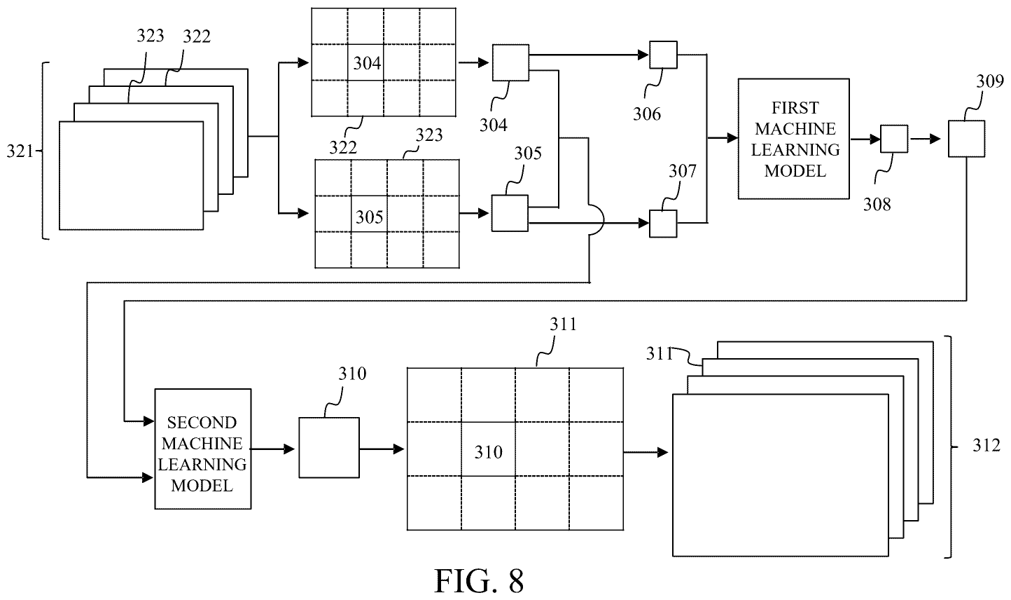

FIG. 8 illustrates a flow of the estimation processing (estimation phase) using the trained first machine learning model and the trained second machine learning model performed in the image estimator 223 of the image pickup apparatus 205. The trained machine learning model is a machine learning model whose weights have been determined by training in the training phase.

In the estimation phase, the image estimator 223 first extracts a first original image 322 and a second original image 323 from an original moving image 321. Next, the first original image 322 and the second original image 323 are divided to generate a first image 304 and a second image 305. Next, the first image 304 and the second image 305 are reduced to generate a third image 306 and a fourth image 307.

Next, the image estimator 223 inputs the third image 306 and the fourth image 307 into a first machine learning model to generate a first motion vector 308. Next, the first motion vector 308 is enlarged to generate a second motion vector 309. Next, the first image 304, the second image 305, and the second motion vector 309 are input into a second machine learning model to generate a third image 306. Next, the image estimator 223 concatenates the fifth image 310 to generate a target image 311. Finally, the image estimator 223 generates a target moving image 312 from the target image 311.

The fifth image 310 is an upscaled version of the first image 304, and the target image 311 is an upscaled version of the first original image 322. The target moving image 312 is an upscaled version of the original moving image 321.

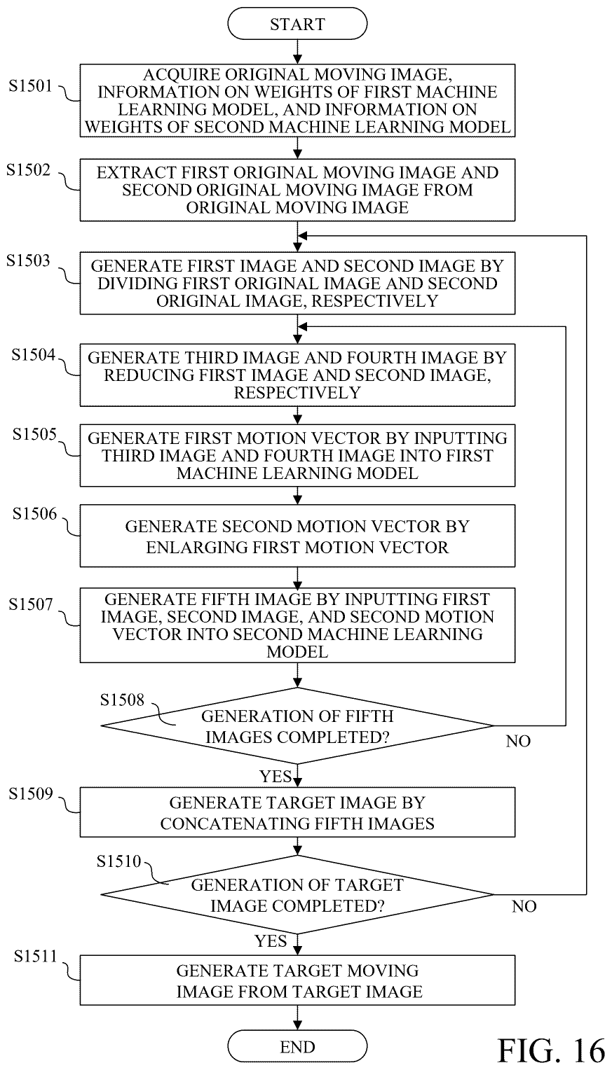

A flowchart in FIG. 16 illustrates processing (image processing method) performed by the image estimator 223 in the estimation phase. First, in step S1501, the acquiring unit 223a acquires the original moving image 321, weight information on the first machine learning model, and weight information on the second machine learning model. In this example, the original moving image 321 is a captured moving image generated by the optical system 221 and the image sensor 222. The acquired original moving image 321 may be a part of the captured moving image. For example, the moving image may be a moving image obtained by cropping the captured moving image in the spatial or temporal direction, or a moving image having a lower frame rate than that of the captured moving image, which is generated by extracting frame images at regular intervals from the captured moving image. The original moving image 321 may be expressed in grayscale or may have a plurality of channel components. The weight information on the first machine learning model and the weight information on the second machine learning model are previously read out from the memory 211 and stored in the memory 224.

Next, in step S1502, the calculator 223b extracts a first original image 322 and a second original image 323 from the original moving image 321. The first original image 322 and the second original image 323 are frame images that constitute the original moving image 321. The first original image 322 is an image to be upscaled, corresponding to the target image 311 generated in step S1509. In this example, as illustrated in FIG. 8, the second original image 323 is a frame image adjacent to the first original image 322 in the original moving image 321, but it may not be an adjacent frame image. In the first image 304 and the second image 305 generated in step S1503, the second original image 323 is to be selected so that the second image 305 includes at least a part of the object included in the first image 304.

Next, in step S1503, the calculator 223b divides the first original image 322 and the second original image 323, respectively, to generate the first image 304 and the second image 305. Both the first image 304 and the second image 305 are images of the same third size. In other words, the first image 304 and the second image 305 are images obtained by cropping an area of the third size at the same position in the first original image 322 and the second original image 323, respectively. In this example, the third size has 256×256 pixels. The first original image 322 may be divided so that a common area is included among the plurality of first images 304. This reason will be explained later in step S1509. If the sizes of the first original image 322 and the second original image 323 are the same as the third size, the division processing of step S1503 may be omitted, and the associated concatenation processing of step S1509 may also be omitted.

Next, in step S1504, the calculator 223b reduces the first image 304 and the second image 305, respectively, to generate the third image 306 and the fourth image 307. The reduction from the first image 304 to the third image 306 and the reduction from the second image 305 to the fourth image 307 are performed using the same reduction processing that converts from image to image. The reduction processing according to this example is downsampling, which extracts only one pixel from a plurality of pixels. The third image 306 and the fourth image 307 are both images of the same first size. In this example, the first size is 128×128 pixels. Thus, a reduction ratio from the first image 304 to the third image 306 and a reduction ratio from the second image 305 to the fourth image 307 are twice in the width direction and twice in the height direction of the image.

Next, in step S1505, the estimator 223c inputs the third image 306 and the fourth image 307 into a first machine learning model to generate a first motion vector 308. The first motion vector 308 is a vector that represents the movement of corresponding pixels between the third image 306 and the fourth image 307. In this example, the first motion vector 308 has the same first size (128×128 pixels) as that of the third image 306 and the fourth image 307, but the size of the first motion vector 308 is not limited to this implementation. In this example, the first motion vector 308 is a vector that indicates the movement from the fourth image 307 to the third image 306 for each image in the third image 306. In this example, the third motion vector is two types of two-dimensional maps, and each two-dimensional map indicates a moving amount in the horizontal or vertical direction for each pixel position in the third image 306.

Next, in step S1506, the calculator 223b enlarges the first motion vector 308 to generate a second motion vector 309. The enlargement processing of the first motion vector 308 is processing independent of the first machine learning model. This enlargement processing may be enlargement processing using a machine learning model or enlargement processing without using a machine learning model, as long as it is independent of the first machine learning model. In this example, the enlargement processing is processing using the bicubic interpolation. More specifically, the enlargement processing generates the second motion vector 309 by multiplying each pixel corresponding to the motion vector obtained by enlarging the first motion vector 308 by the bicubic interpolation by an enlargement magnification (twice in this example, as described later). In this example, the enlargement magnification in this enlargement processing is the same as that of the reduction magnification in the reduction processing of S1504, and is twice in the width direction and twice in the height direction of the map. That is, the size of the second motion vector is 256×256 pixels. In this example, the second motion vector 309 has the same size as that of the first image 304 and the second image 305.

Next, in step S1507, the estimator 223c inputs the first image 304, the second image 305, and the second motion vector 309 into the second machine learning model to generate the fifth image 310. Here, the estimator 223c first generates a third warped image using the second image 305 and the second motion vector 309 inside the second machine learning model. The third warped image is an image in which the second image 305 is aligned so that it becomes an image equivalent to the first image 304 by moving the pixels of the second image 305 using the second motion vector 309. At this time, the estimator 223c calculates each pixel value of the third warped image from the pixel value of the second image 305 using a known interpolation method such as the nearest neighbor interpolation, the bilinear interpolation, and the bicubic interpolation. In this example, the estimator 223c generates a first motion vector 308 indicating the movement from the fourth image 307 to the third image 306 for each image of the third image 306 in step S1505. At this time, the backward warping is adopted to align the second image 305 so that it becomes an image equivalent to the first image 304 using a second motion vector 309 obtained by enlarging the first motion vector 308.

Next, the estimator 223c generates a fifth image 310 using the first image 304 and the third warped image inside the second machine learning model. The first image 304 and the third warped image are concatenated in the channel direction in the connection layer included in the second machine learning model. The fifth image 310 is an image obtained by upscaling the first image 304. The fifth image 310 in this example is an image obtained by upscaling the first image 304 twice in the width direction and twice in the height direction, and having 512×512 pixels.

Next, in step S1508, the calculator 223b determines whether or not the generation of the fifth image 310 has been completed for all pairs of the first image 304 and the second image 305. In a case where it is determined that the generation of all the fifth images 310 has not been completed, the flow returns to step S1504, and the calculator 223b generates the fifth image 310 from a new pair of the first image 304 and the second image 305. In a case where it is determined that the generation of all the fifth images 310 has been completed, the flow proceeds to step S1509.

In step S1509, the calculator 223b concatenates the fifth images 310 to generate the target image 311. Here, the target image 311 is generated by concatenating the fifth images 310 so that the target image 311 becomes an image obtained by upscaling the first original image 322. In this example, the target image 311 is an image obtained by upscaling the first original image 322 twice in the width direction and twice in the height direction.

In the previous step S1503, the first original image 322 may be divided so that the plurality of first images 304 include a common area. Thereby, in step S1509, post-processing can be performed on a common area included in the plurality of fifth images 310 to generate the target image 311. In a case where the first images 304 are divided in step S1503 so as not to include a common area, tile-shaped artifacts may occur in a portion of the target image 311 where the fifth images 310 are concatenated. Thus, artifacts can be reduced by dividing the first images 304 so as to include a common area and generating the target image 311 based on, for example, a weighted average of the plurality of fifth images in the common area included in the fifth images 310.

The generation accuracy in step S1507 may be lower in the peripheral area of the fifth image 310 than in the central area of the fifth image 310. This is because fewer pixels of the first image 304 and the second image 305 are considered in the peripheral area of the fifth image 310 than in the central area of the fifth image 310. Therefore, a target image 311 with higher accuracy can be generated by dividing the first images 304 so that they include a common area, and then generating the target image 311, for example, from the central area of the plurality of fifth images 310.

Next, in step S1510, the calculator 223b determines whether or not the generation of the target image 311 has been completed for all pairs of the first original image 322 and the second original image 323. In a case where it is determined that the generation of all the target images 311 has not been completed, the flow returns to step S1503, and the calculator 223b generates a target image 311 from a new pair of the first original image 322 and the second original image 323. In a case where it is determined that the generation of all the target images 311 has been completed, the flow proceeds to step S1511.

In step S1511, the calculator 223b generates a target moving image 312 from the target image 311. More specifically, the target moving image 312 is generated so that each of the plurality of target images 311 becomes a frame image of the target moving image 312. Then, this processing is completed. In this example, the target moving image 312 is a moving image in which the original moving image 321 is upscaled twice in the width direction and twice in the height direction.

The image sizes in the estimation phase and training phase will be described. In the estimation phase, both the third image 306 and the fourth image 307 input into the first machine learning model have a first size. In the first training phase, the first training image set input into the first machine learning model has a second size. In this example, in order to generate a highly accurate, first motion vector 208 regardless of the first machine learning model itself or the third image 306 and the fourth image 307, the first size may be equal to or smaller than the second size. In this example, each of the first size and the second size has 128×128 pixels.

In the second training phase, the second training image set input into the second machine learning model has a fourth size. In the second training phase, the second training image set is input into the trained first machine learning model to generate a third motion vector. In the estimation phase as well as in the second training phase, the third motion vector, which is an output from the first machine learning model, is to be generated with high accuracy. In order to generate a highly accurate third motion vector regardless of the first machine learning model itself or the second training image set, the fourth size may be equal to or smaller than the second size.

In this example, the fourth size is equal to the second size, 128×128 pixels. Thus, the fourth size may be as large as possible. This is because the larger the fourth size is, the more the second machine learning model can generate a highly accurate fifth image 310 for the larger sizes of the third image 306 and the fourth image 307.

In the estimation phase, each of the first image 304 and the second image 305 input into the second machine learning model has a third size. The third size is not limited based on the second size, which is an image size trained by the first machine learning model. In other words, it is not limited by the fourth size, which is equal to the second size. Therefore, the third size may be equal to or larger than the fourth size. This is one of the effects of one embodiment. In this example, the third size is 256×256 pixels, which is equal to or larger than the fourth size (128×128 pixels).

The effect for setting the third size equal to or larger than the fourth size in this example will be described. Even if the fourth size is limited by the computational resources during training, the degree of freedom to set the optimal third size for the estimation phase is improved. For example, the degree of freedom to set the optimal third size is improved according to the processing speed of the second machine learning model in step S1507 and the generation speed of the target image 311 from the fifth image 310 in step S1509. That is, an optimal third size can be set so as to improve the processing speed in the estimation phase.

In this example, the computational resources during training for processing the first image 304 and the second image 305 of the same fourth size can be reduced in comparison with the conventional method. For example, in generating the fifth image 310 from the third image 306 and the fourth image 307 having 256×256 pixels, the second machine learning model is to be trained with an image size of 256×256 pixels in the conventional method. On the other hand, in this example, training can be performed with the fourth size of 128×128 pixels, so that the computational capacity during training can be reduced to about ¼ of the conventional method.

As described above, this example can achieve a highly accurate upscaling task without being limited based on the image size with which the machine learning model that generates the motion vector is trained.

### Example 4

Example 4 improves (increases) a frame rate of a moving image. More specifically, a new frame image is generated between frame images included in a moving image with a low frame rate, and a moving image with a high frame rate is generated by combining the original frame image and the newly generated frame image. More specifically, a first image, which is at least a part of a frame image included in the moving image with a low frame rate, and a second image, which is at least a part of a frame image adjacent to the first frame image, are reduced to generate a third image and a fourth image. A first motion vector is generated based on the third image and the fourth image using a first machine learning model. A fifth image is generated based on a second motion vector obtained by enlarging the first motion vector, the first image, and the second image, using a second machine learning model. The fifth image is at least a part of a frame image newly generated between the frame image corresponding to the first image and the frame image corresponding to the second image.

As an implementation, this example generates a moving image with a high frame rate by generating a new single frame image at the center of two consecutive frame images included in the original moving image with a low frame rate. That is, the generated moving image has a frame rate approximately twice as high as that of the original moving image. The fifth image is an image located at the center of the first image and the second image, which are temporally consecutive. However, this example is not limited to this implementation, and a moving image with a higher frame rate may be generated by generating a plurality of new fifth images between the first image and the second image. This example generates the fifth image between the first image and the second image based on the first image and the second image, but may generate the fifth image based on three or more images that are at least a part of the three or more frame images included in the original moving image.

The frame-rate increasing task performed in this example for generating a fifth image between the first image and the second image based on the first image and the second image can generate the fifth image based on the average or weighted average of the pixel values of the first image and the pixel values of the second image. By using a motion vector in this task, a fifth image with higher accuracy can be generated by adapting to the movement of the object between the first image and the second image.

The accuracy of generating the fifth image strongly depends on the accuracy of generating the motion vector. In a case where the accuracy of generating the motion vector is low, the pixels of the fifth image are generated from pixels of the first image and the second image that are not intended, and artifacts appear in the fifth image. In contrast, the first machine learning model in this example can generate the first motion vector with high accuracy for the size (first size) of the third image and the fourth image that is limited based on the image size (second size) trained by the first machine learning model. Using the highly accurate first motion vector can generate the fifth image with reduced artifacts. In this example, this is effective for the size (third size) of the first image and the second image that is not limited based on the second size.

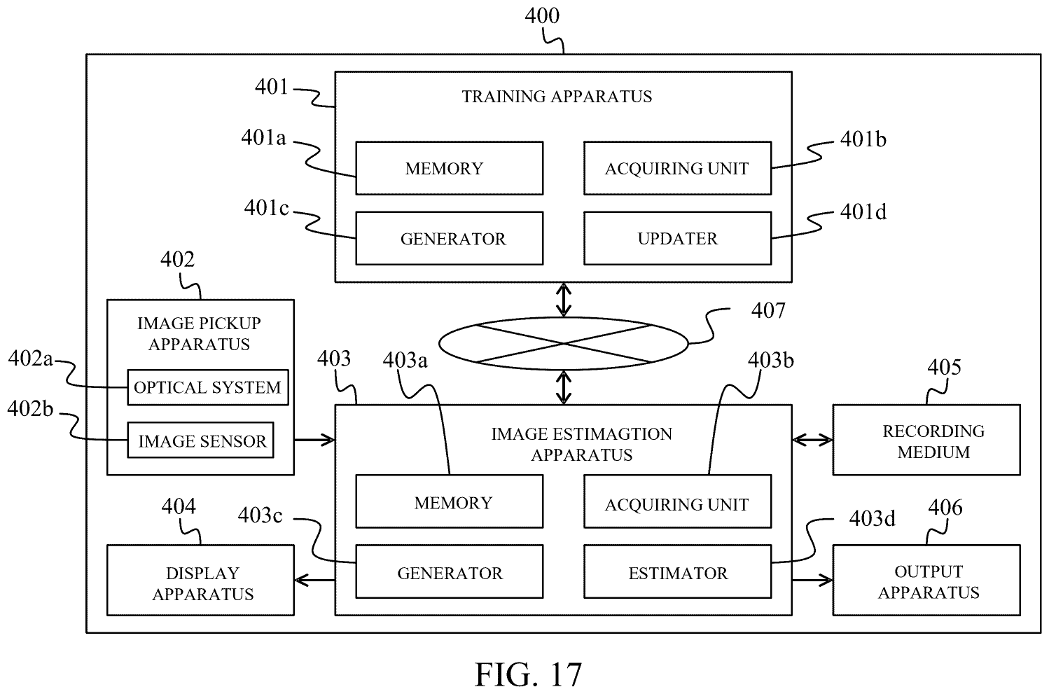

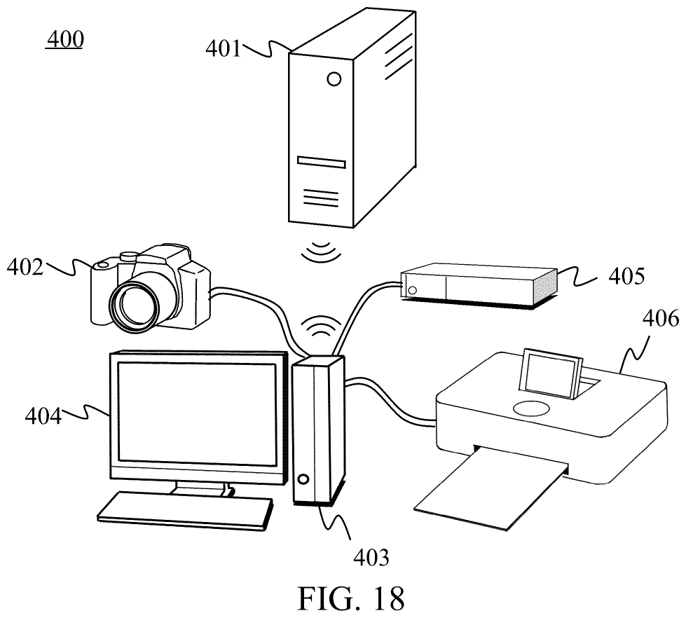

FIG. 17 illustrates the configuration of an image processing system 400 according to this example. FIG. 18 illustrates the appearance of the image processing system 400. The image processing system 400 includes a training apparatus 401, an image pickup apparatus 402, an image estimation apparatus 403 as an image processing apparatus, a display apparatus 404, a memory 405, an output apparatus 406, and a network 407.

The training apparatus 401 includes a computer such as a personal computer, includes a memory 401a, an acquiring unit 401b, a generator 401c, and an updater 401d, and operates according to a program to determine the weights of the machine learning model.

The image pickup apparatus 402 includes an optical system 402a and an image sensor 402b. The optical system 402a condenses light incident from space in which an object exists to form an object image. The optical system 402a has functions such as zoom, aperture stop, and autofocus as necessary. The image sensor 402b converts the object image formed by the optical system 402a into an electrical signal and generates a captured moving image as image data.

The image estimation apparatus 403 includes a memory 403a, an acquiring unit 403b, a generator 403c, and an estimator 403d. The image estimation apparatus 403 includes a personal computer, operates according to a program, and increases the frame rate of the captured moving image generated by the optical system 221 and the image sensor 222. Hence, the image estimation apparatus 403 generates a first motion vector using a first machine learning model based on a third image and a fourth image obtained by reducing a first image and a second image, which are parts of a frame image of a captured moving image. The image estimation apparatus 403 generates a fifth image using a second machine learning model based on a second motion vector obtained by enlarging the first motion vector, the first image, and the second image. Then, a high frame-rate moving image is generated in which a frame rate of the captured image is increased, using the fifth image.

The fifth image is generated using weights previously determined by the training apparatus 401. The memory 403a stores the weights. Details of the processing performed by the image estimation apparatus 403 will be described later.

The high frame rate moving image is output to at least one of the display apparatus 404, the memory 405, and the output apparatus 406. The display apparatus 404 includes a liquid crystal display, a projector, or the like. The user can perform editing work etc. while confirming the image in the middle of processing via the display apparatus 404. The memory 405 includes a semiconductor memory, a hard disk drive, a server on a network, etc., and stores the high frame rate moving image. The output apparatus 406 is a printer etc.

Similarly to Example 3, the processing performed in this example can be classified into generation of training data for the first machine learning model, training of weights for the first machine learning model (first training phase), generation of training data for the second machine learning model, training of weights for the second machine learning model (second training phase), and estimation by the first machine learning model and the second machine learning model using the trained weights (estimation phase).

The training apparatus 401 performs processing to generate training data for the first machine learning model according to the flowchart of FIG. 12 described in Example 3. In this example, the processing of steps S1101 and S1102 is performed by the acquiring unit 401b and the generator 401c instead of the acquiring unit 212 and the generator 213 in Example 3.

The training apparatus 401 performs processing of training weights of the first machine learning model in the first training phase in accordance with the flowchart of FIG. 13 described according to Example 3. In this example, the processes of steps S1201 to S1205 are performed by the acquiring unit 401b, the generator 401c, and the updater 401d instead of the acquiring unit 212, the generator 213, and the updater 214 in Example 3, respectively.

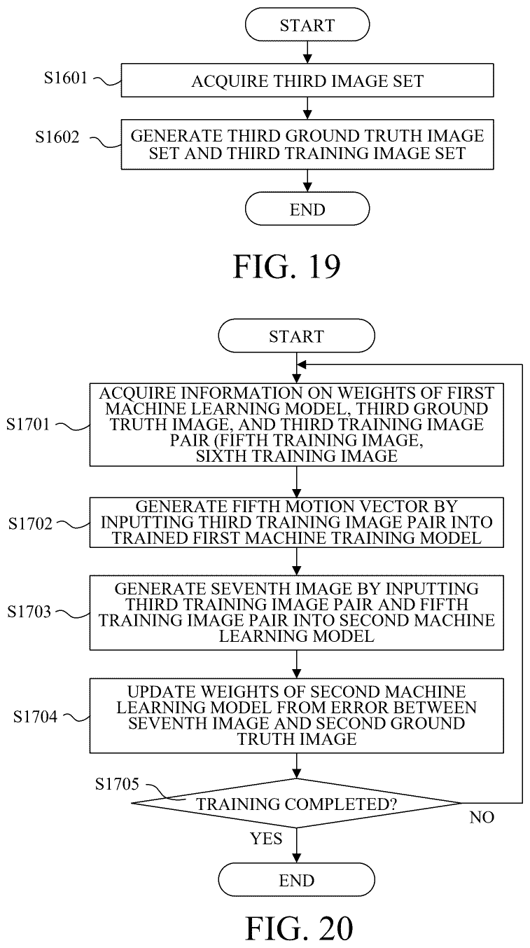

A flowchart of FIG. 19 illustrates the processing of generating training data for the second machine learning model performed in training apparatus 401. The training data is a third ground truth image set and a third training image set, and is used to train the second machine learning model. The training apparatus 401 determines the weights of the second machine learning model so as to reduce a difference between a seventh image obtained by inputting the third training image set to the second machine learning model in the next second training phase, and the third ground truth image set. The third training image set corresponds to the second training image set in Example 3 in that it is input into the second machine learning model in the second training phase. In this example, the training apparatus 401 performs the processing of generating training data for the second machine learning model, but another apparatus may perform this processing.

In step S1601, the acquiring unit 401b acquires a third image set from the memory 401a. The third image set includes one or more first image triplets. The first image triplet includes three images that include the same object at different positions. Each image that constitutes the first image triplet in the third image set may constitute a first image triplet different from another image included in the third image set. The third image set may include a captured image or a CG image. For example, the third image set may include a frame image extracted from a captured moving image. The third image set may also be a public dataset such as a REDS dataset.

In this example, the third image set is generated from a captured moving image having the same frame rate as that of a high frame rate moving image that is finally to be generated. The first image triplet includes three consecutive frame images extracted from this captured moving image. The third image set may include images containing various objects. For example, the third image set may include images that contain edges, textures, gradients or plateaus with various intensities and orientations. Thereby, the robustness of the second machine learning model can be improved for the objects contained in the first image and the second image.

The third image set may include images including image quality degradation of the first image and the second image. The image quality degradation is the same as that described in Example 3. Thereby, the robustness of the second machine learning model can be improved against image quality degradation of the first image and the second image.

Each image in the first image triplet may include a plurality of objects having different moving amounts and moving directions. The plurality of first image triplets included in the third image set may include a plurality of objects having different moving amounts and moving directions. Thereby, the robustness of the second machine learning model can be improved against the motion included between the first image and the second image.

Next, in step S1602, the generator 401c generates a third ground truth image set and a third training image set. The third ground truth image set includes one or more third ground truth images, and the third training image set includes one or more pairs of third training images. One third ground truth image corresponds to one set of third training image pairs. The third training image pair is an image pair having a predetermined size (fourth size), and in this example, the fourth size has 128×128 pixels. The third ground truth image is an image having the same fourth size as that of the third training image pair.

The third training image pair and the corresponding third ground truth image pair include the same object. As described above, in this example, the first image triplet is three consecutive frame images extracted from a captured moving image having the same frame rate as the high frame rate moving image to be finally generated. This example generates the third training image pair by cropping an area having the fourth size from a first frame image and a last frame image constituting the first image triplet. This example generates the third ground truth image by cropping an area having the fourth size from a middle frame image constituting the first image triplet. At this time, the third training image pair or the third ground truth image is cropped from the same position as that of the first image triplet. The third ground truth image set and the third training image set may have at least a portion in common with the first training image set that is used to train the first machine learning model.

A flowchart in FIG. 20 illustrates the processing of training the weights of the second machine learning model performed in the training apparatus 401 as the second training phase. Hereinafter, one image of the third training image pair will be referred to as a fifth training image, and the other image will be referred to as a sixth training image. The seventh image described later is an image that is targeted to be a central frame image of the fifth training image and the sixth training image, in a case where the fifth training image and the sixth training image are frame images that constitute the same moving image.

In the second training phase, the training apparatus 401 first inputs the third training image pair included in the third training image set, which is the training data, into the first machine learning model trained in the first training phase, and obtains a fifth motion vector indicating the movement of corresponding pixels in the third training image pair. Next, in the second machine learning model, a sixth motion vector and a seventh motion vector are generated based on the fifth motion vector, which respectively indicate the movement of corresponding pixels between the fifth training image and the seventh image to be generated, and between the sixth training image and the seventh image.

Next, using the sixth motion vector in the second machine learning model, the training apparatus 401 generates a fourth warped image, which is an image aligned so that the fifth training image becomes an image equivalent to the seventh image to be generated. Similarly, using the seventh motion vector in the second machine learning model, the training apparatus 401 generates a fifth warped image, which is an image aligned so that the sixth training image becomes an image equivalent to the seventh image to be generated. Then, the training apparatus 401 generates a seventh image using the fourth warped image and the fifth warped image.

Finally, the training apparatus 401 determines the weights of the second machine learning model so as to reduce a difference between the seventh image and the third ground truth image.

In step S1701, the acquiring unit 401b acquires weight information on the first machine learning model, one or more third ground truth images, and one or more sets of third training image pairs from the memory 401a

Next, in step S1702, the generator 401c inputs the third training image pair into the trained first machine learning model to generate a fifth motion vector. The trained first machine learning model is the first machine learning model whose weights have been determined by training in the first training phase. The fifth motion vector is a vector that represents the movement of corresponding pixels in the third training image pair, i.e., between the fifth training image and the sixth training image. In this example, the fifth motion vector has the same size as that of the third training image pair, but the size of the fifth motion vector is not limited to this implementation. In this example, the fifth motion vector is two types of vectors that indicate the movement of corresponding pixels in the third training image pair. One type of vector indicates the movement from the sixth training image to the fifth training image for each pixel of the fifth training image. The other type of vector indicates the movement from the fifth training image to the sixth training image for each pixel of the sixth training image. In this example, the fifth motion vector is four types of two-dimensional maps, and each two-dimensional map indicates a moving amount in the horizontal or vertical direction for each pixel position of the fifth training image or the sixth training image.

Next, in step S1703, the generator 401c inputs the third training image pair and the fifth motion vector into the second machine learning model to generate a seventh image. Thus, the generator 401c first generates a sixth motion vector and a seventh motion vector using the fifth motion vector inside the second machine learning model. The sixth motion vector is a vector that indicates the movement of corresponding pixels between the fifth training image and the seventh image.

In this example, the sixth motion vector indicates the movement from the seventh image to the fifth training image for each pixel of the fifth training image. More specifically, the generator 401c generates the sixth motion vector by multiplying by ½ each pixel of a vector among the fifth motion vector, which indicates the movement from the sixth training image to the fifth training image for each pixel of the fifth training image.

The seventh motion vector is a vector that indicates the movement of corresponding pixels between the sixth training image and the seventh image, and indicates the movement from the seventh image to the sixth training image for each pixel of the sixth training image. More specifically, the generator 401c generates the seventh motion vector by multiplying by ½ each pixel of a vector among the fifth motion vector, which indicates the movement from the fifth training image to the sixth training image for each pixel of the sixth training image.

Next, the generator 401c generates a fourth warped image and a fifth warped image using the third training image pair, the sixth motion vector, and the seventh motion vector inside the second machine learning model. The fourth warped image is an image equivalent to the seventh image generated based on the fifth training image and the sixth motion vector. The fourth warped image is generated by moving the pixels of the fifth training image using the sixth motion vector. More specifically, the generator 401c calculates each pixel value of the fourth warped image from the pixel values of the fifth training image using a known interpolation method such as the nearest neighbor interpolation, the bilinear interpolation, and the bicubic interpolation.

This example adopts forward warping, in which the fifth training image is aligned so that it becomes an image equivalent to the seventh image using a sixth motion vector indicating the movement from the seventh image to the fifth training image for each pixel of the fifth training image. Alternatively, this embodiment may adopt backward warping, in which the fifth training image is aligned so that it becomes an image equivalent to the seventh image using a motion vector indicating the movement from the fifth training image to the seventh image for each pixel of the seventh image. This example adopts the forward warping in the second machine learning model in the estimation phase, and thus adopts the forward warping even in step S1703. Thus, using the same image alignment method in the second machine learning model between the second training phase and the estimation phase can train the second machine learning model that generates a fifth image with higher accuracy. This is similarly applicable to the generation of the fifth warped image described below.

The fifth warped image is an image equivalent to the seventh image generated based on the sixth training image and the seventh motion vector. The fifth warped image is generated by moving the pixels of the sixth training image using the seventh motion vector. More specifically, the generator 401c calculates each pixel value of the fifth warped image from the pixel values of the sixth training image using a known interpolation method such as the nearest neighbor interpolation, the bilinear interpolation, and the bicubic interpolation.

Finally, the generator 401c generates a seventh image from the fourth warped image and the fifth warped image inside the second machine learning model. More specifically, the seventh image is generated based on an average or weighted average of the pixel values of the fourth warped image and the pixel values of the fifth warped image. This example generates the seventh image by setting the average of the pixel values of the fourth warped image and the pixel values of the fifth warped image to the pixel values of the seventh image.

The contribution ratio of the fourth warped image and the fifth warped image to the generation of the seventh image may be determined inside the second machine learning model, and the seventh image may be generated according to the contribution ratio. The contribution ratio may be determined for each pixel of the seventh image. For example, the fourth warped image and the fifth warped image may be input into the CNN and the contribution ratio of each pixel of the fourth warped image and the fifth warped image to the generation of the seventh image may be determined. Even in the estimation phase, the fifth image can be generated with high accuracy in a case where the second machine learning model performs similar processing and the contribution ratio of the first image and the second image is adjusted for each pixel of the first image and the second image.

After the seventh image is generated, a residual component for each pixel of the seventh image may be calculated based on at least the fourth warped image and the fifth warped image inside the second machine learning model, and this residual component may be added to the seventh image to generate a new seventh image. For example, the fourth warped image and the fifth warped image may be input into a CNN to determine a residual component for each pixel of the seventh image. Even in the estimation phase, the second machine learning model performs similar processing, so that a fifth image with higher accuracy can be generated.

Next, in step S1704, the updater 401d updates (determines) the weights of the second machine learning model based on an error between the seventh image and the third ground truth image. This example sets a loss function to the Charbonieros of a difference in pixel value between the seventh image and the third ground truth image. However, the loss function is not limited to this example. In a case where a plurality of pairs of third training images are acquired in step S1701, a value of a loss function is calculated for each pair. The weights are updated from the calculated values of the loss function using the backpropagation method or the like.

Next, in step S1705, the updater 401d determines whether the training of the second machine learning model has been completed. The completion of the training can be determined, for example, by whether the number of iterations of the weight update has reached a predetermined number, or whether a change amount in the weights during update is smaller than a predetermined value. In a case where it is determined that the training of the weights has not been completed, the flow returns to step S1701, and the acquiring unit 401b acquires one or more new pairs of third training images and a third ground truth image. In a case where it is determined that the training of the weights has been completed, the updater 401d ends the training and stores the weight information in the memory 401a.

Similarly to Example 3, even in this example, after training of the first machine learning model is performed in the first training phase, the second machine learning model is trained in the second training phase. This example is not limited to this implementation, and the first and second machine learning models may be trained jointly from the beginning. After the first and second training phases are performed, a third training phase may be provided for jointly updating the weights of the first and second machine learning models.

In this example, in the second training phase, the first machine learning model generates a fifth motion vector that indicates the movement of corresponding pixels in the third training image pair. This example is not limited to this implementation, and the first machine learning model may generate both a sixth motion vector and a seventh motion vector in the second training phase. More specifically, the first machine learning model may be trained to generate both a motion vector between one or the other image of the first training image pair and the central image of the first training image pair. The central image of the first training image pair is an image that is targeted to be the central frame image of the first training image pair in a case where it is assumed that the first training image pair are frame images that constitute the same moving image. In this case, in the estimation phase, the first machine learning model generates a motion vector indicating the movement of corresponding pixels between the first image or the second image and the fifth image as the first motion vector.

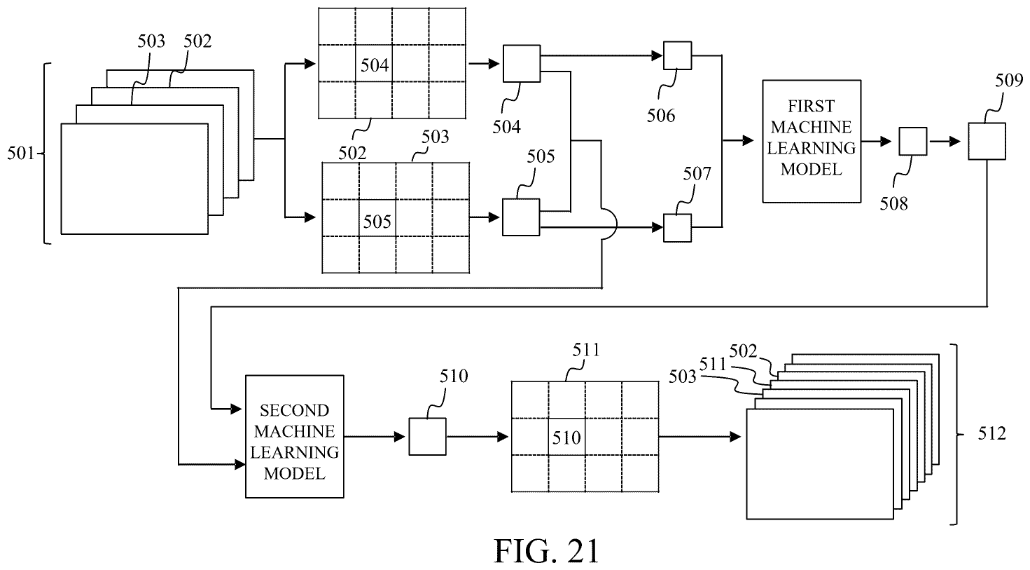

FIG. 21 illustrates a flow of estimation processing (estimation phase) by the trained first machine learning model and trained second machine learning model performed in the image estimation apparatus 403. The trained machine learning model is a machine learning model whose weights have been determined by training in the training phase.

In the estimation phase, the image estimation apparatus 403 first extracts a first original image 502 and a second original image 503 from an original moving image 501. Next, each of the first original image 502 and the second original image 503 is divided to generate a first image 504 and a second image 505. Next, the first image 504 and the second image 505 are reduced to generate a third image 506 and a fourth image 507, respectively.

Next, the image estimation apparatus 403 inputs the third image 506 and the fourth image 507 into the first machine learning model to generate a first motion vector 508. Next, the image estimation apparatus 403 enlarges the first motion vector 508 to generate a second motion vector 509. Next, the image estimation apparatus 403 inputs the first image 504, the second image 505, and the second motion vector 509 into a second machine learning model to generate a fifth image 510. Next, the fifth image 510 is concatenated to generate a target image 511.

Finally, the image estimation apparatus 403 generates a target moving image 512 from the original moving image 501 and the target image 511. The fifth image 510 is an image located at the center of the first image 504 and the second image 505. The target image 511 is a frame image located at the center of the first original image 502 and the second original image 503. The target moving image 512 is a moving image in which the frame rate of the original moving image 501 has been increased approximately double.

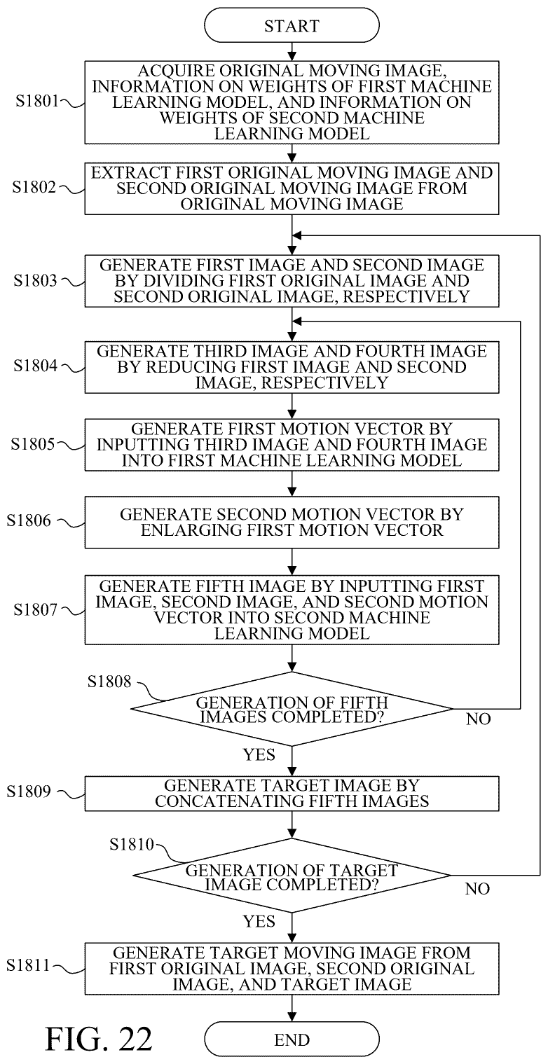

A flowchart in FIG. 22 illustrates processing performed by the image estimation apparatus 403 in the estimation phase. First, in step S1801, the acquiring unit 403b acquires the original moving image 501, the weight information on the first machine learning model, and the weight information on the second machine learning model. In this example, the original moving image 501 is a captured moving image generated by the optical system 402a and the image sensor 402b. The original moving image 501 to be acquired may be a part of a captured moving image. For example, it may be a moving image obtained by cropping the captured moving image in the spatial direction or the time direction. The original moving image 501 may also be expressed in grayscale or may have a plurality of channel components. The weight information on the first machine learning model and the weight information on the second machine learning model are previously read out from the memory 401a and stored in the memory 403a.

Next, in step S1802, the generator 403c extracts a first original image 502 and a second original image 503 from the original moving image 501. The first original image 502 and the second original image 503 are frame images that constitute the original moving image 501. In this example, as illustrated in FIG. 21, the second original image 503 is a frame image that is adjacent to the first original image 502 in the original moving image 501.

Next, in step S1803, the generator 403c divides the first original image 502 and the second original image 503, respectively, to generate a first image 504 and a second image 505. Both the first image 504 and the second image 505 are images of the same third size. That is, the first image 504 and the second image 505 are images obtained by cropping an area having the third size from the same position of the first original image 502 and the second original image 503, respectively. In this example, the third size has 256×256 pixels. As in Example 3, the first original image 502 may be divided so that a common area is included among the plurality of first images 504. In a case where the sizes of the first original image 502 and the second original image 503 are the same as the third size, the division processing of step S1803 may be omitted, and the accompanying concatenation processing of step S1809 may also be omitted.

Next, in step S1804, the generator 403c reduces the first image 504 and the second image 505, respectively, to generate a third image 506 and a fourth image 507. The reduction from the first image 504 to the third image 506 and the reduction from the second image 505 to the fourth image 507 are performed using the same reduction processing that converts from an image to an image. The reduction processing in this example is downsampling, which extracts only one pixel from a plurality of pixels.

The third image 506 and the fourth image 507 are both images of the same first size. In this example, the first size has 128×128 pixels. Therefore, a reduction ratio from the first image 504 to the third image 506 and a reduction ratio from the second image 505 to the fourth image 507 are both twice in the width direction and twice in the height direction of the image.

Next, in step S1805, the estimator 403d inputs the third image 506 and the fourth image 507 into a first machine learning model to generate a first motion vector 508. The first motion vector 508 is a vector that represents the movement of corresponding pixels between the third image 506 and the fourth image 507. In this example, the first motion vector 508 has the same first size (128×128 pixels) as that of the third image 506 and the fourth image 507. The size of the first motion vector 508 is not limited to this implementation.

In this example, the first motion vector is two types of vectors indicating the movement of corresponding pixels between the third image 506 and the fourth image 507. One type of vector indicates the movement from the fourth image 507 to the third image 506 for each image of the third image 506. The other type of vector indicates the movement from the third image 506 to the fourth image 507 for each image of the fourth image 507. In this example, the first motion vector is four types of two-dimensional maps, and each two-dimensional map indicates a moving amount in the horizontal or vertical direction for each pixel position of the third image 506 or the fourth image 507.

Next, in step S1806, the generator 403c enlarges the first motion vector 508 to generate a second motion vector 509. The enlargement processing for the first motion vector 508 is processing independent of the first machine learning model. This enlargement processing may be enlargement processing using a machine learning model, or may be enlargement processing without using a machine learning model, as long as it is independent of the first machine learning model. In this example, the enlargement processing is processing using the bicubic interpolation. More specifically, the enlargement processing generates the second motion vector 509 by multiplying each pixel of the motion vector obtained by enlarging the first motion vector 508 by the bicubic interpolation by an enlargement magnification (twice in this example as described later). In this example, the enlargement magnification in this enlargement processing is the same as the reduction magnification in the reduction processing in step S1804, and is twice in the width direction and twice in the height direction of the map. That is, the size of the second motion vector has 256×256 pixels. In this example, the second motion vector 509 has the same size as that of the first image 504 and the second image 505.

Next, in step S1807, the estimator 403d inputs the first image 504, the second image 505, and the second motion vector 509 into the second machine learning model to generate the fifth image 510. Here, the estimator 403d first generates an eighth motion vector and a ninth motion vector using the second motion vector 509 inside the second machine learning model. The eighth motion vector is a vector indicating the movement of corresponding pixels between the first image 504 and the fifth image 510. In this example, the eighth motion vector indicates the movement from the fifth image 510 to the first image 504 for each image of the first image 504. More specifically, the eighth motion vector is generated by multiplying by 1/2 each pixel of the vector indicating the movement from the second image 505 to the first image 504 for each image of the first image 504, among the second motion vector 509.

The ninth motion vector is a vector indicating the movement of corresponding pixels between the second image 505 and the fifth image 510. In this example, the ninth motion vector indicates the movement from the fifth image 510 to the second image 505 for each image of the second image 505. More specifically, the ninth motion vector is generated by multiplying by ½ each pixel of the vector indicating the movement from the first image 504 to the second image 505 for each image of the second image 505, among the second motion vectors 509.

Next, the estimator 403d generates a sixth warped image and a seventh warped image using the first image 504, the second image 505, the eighth motion vector, and the ninth motion vector inside the second machine learning model. The sixth warped image is an image equivalent to the fifth image 510 generated based on the first image 504 and the eighth motion vector. The sixth warped image is generated by moving the pixels of the first image 504 using the eighth motion vector. More specifically, the pixel values of the sixth warped image are calculated from the pixel values of the first image 504 using a known interpolation method such as the nearest neighbor interpolation, the bilinear interpolation, and the bicubic interpolation.

This example adopts forward warping, in which the first image 504 is aligned so that it becomes an image equivalent to the fifth image 510, using an eighth motion vector indicating the movement from the fifth image 510 to the first image 504 for each image of the first image 504. The forward warping is similarly used for the seventh warped image.

The seventh warped image is an image equivalent to the fifth image 510, generated based on the second image 505 and the ninth motion vector. The seventh warped image is generated by moving the pixels of the second image 505 using the ninth motion vector. More specifically, a known interpolation method such as the nearest neighbor interpolation, the bilinear interpolation, and the bicubic interpolation is used to calculate each pixel value of the seventh warped image from the pixel values of the second image 505.

Finally, the estimator 403d generates a fifth image 510 from the sixth warped image and the seventh warped image within the second machine learning model. More specifically, the estimator 403d generates the fifth image 510 based on an average or weighted average of the pixel values of the sixth warped image and the pixel values of the seventh warped image. This example generates the fifth image 510 by setting the average of the pixel values of the sixth warped image and the pixel values of the seventh warped image to the pixel values of the fifth image 510.

Next, in step S1808, the generator 403c determines whether or not generation of the fifth image 510 has been completed for all pairs of the first image 504 and the second image 505. In a case where it is determined that generation of all fifth images 510 has not been completed, the flow returns to step S1804, where the generator 403c generates a fifth image 510 from a new pair of the first image 504 and the second image 505. In a case where it is determined that generation of all fifth images 510 has been completed, the flow proceeds to step S1809.

In step S1809, the generator 403c concatenates the fifth images 510 to generate a target image 511. In this example, the target image 511 is an image located at the center of the first image 504 and the second image 505.

Next, in step S1810, the generator 403c determines whether or not the generation of the target image 511 has been completed for all pairs of the first original image 502 and the second original image 503. In a case where it is determined that the generation of all the target images 511 has not been completed, the flow returns to step S1803, where the generator 403c generates a target image 511 from a new pair of the first original image 502 and the second original image 503. In a case where it is determined that the generation of all the target images 511 has been completed, the flow proceeds to step S1811.

In step S1811, the generator 403c generates a target moving image 512 from the first original image 502, the second original image 503, and the target image 511. More specifically, the target moving image 512 is generated by placing the target image 511 at the center of the first original image 502 and the second original image 503. In this example, the target moving image 512 is a moving image in which a frame rate is increased approximately twice as high as that of the original moving image 501.

This example can achieve a highly accurate up-frame task without being limited based on the image size trained by the machine learning model that generates the motion vector.

### Example 5

Example 5 improves the resolution of an image, and generates a single image (super-resolution image: referred to as a resolution-improved image hereinafter) with a higher resolution than those of two images using the two images (referred to as low-resolution images hereinafter) that contain at least a part of the same object at different positions. Thus, a first image that is at least a part of one of the low-resolution images and a second image that is at least a part of the other of the low-resolution images are reduced to generate a third image and a fourth image, respectively. A first motion vector is generated using a first machine learning model based on the third image and the fourth image. A high-resolution fifth image corresponding to the first image is generated using a second machine learning model based on a second motion vector obtained by enlarging the first motion vector, the first image, and the second image. The fifth image is at least a part of one resolution-improved image to be generated. The fifth image may be an upscaled image of the first image, or may be an image in which noise, blur, shake, and the like are removed from the first image. The effect obtained in this example is the same as that of Example 3.

This example generates a single resolution-improved image using two low-resolution images generated by continuous imaging (continuous shooting) using the same optical system and image sensor. This example is not limited to this implementation, and the single resolution-improved image may be generated using two low-resolution images generated by imaging using the same optical system and image sensor but at different positions of the image sensor. The single resolution-improved image may be generated using two low-resolution images generated by imaging using different optical systems and image sensors. This example generates the single resolution-improved image using two low-resolution images, but may use a larger number of low-resolution images as in Example 3.

This example uses the same image processing system 200 as that of Example 3. For Example 3, the image estimator 223 according to this example uses two captured images generated by continuous shooting using the optical system 221 and image sensor 222 to generate a resolution-improved image corresponding to one of the captured images.

Similarly to Example 3, the processing performed in this example can be classified into generation of training data for the first machine learning model, training of weights for the first machine learning model (first training phase), generation of training data for the second machine learning model, training of weights for the second machine learning model (second training phase), and estimation by the first machine learning model and the second machine learning model using the trained weights (estimation phase). This example is similar to Example 3 except for the estimation phase.

The estimation phase according to this example will be explained based on the estimation phase of Example 3. The steps in the estimation phase in this example are steps S1503 to S1509 of the steps in the estimation phase of Example 3. In this example, the first original image and the second original image in Example 3 correspond to two low-resolution images. The target image in Example 3 corresponds to the single resolution-improved image to be generated in this example.

This example can achieve the task of increasing the resolution of an image without being limited based on the image size trained by the machine learning model that generates motion vectors.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each example can provide an image processing method, an image processing apparatus, and a storage medium, each of which can perform highly accurate processing using a machine learning model.

This application claims priority to Japanese Patent Application No. 2024-042985, which was filed on Mar. 19, 2024, and Japanese Patent Application No. 2024-043029, which was filed on Mar. 19, 2024, and which are hereby incorporated by reference herein in their entirety.

What is claimed is:

1. An image processing method comprising:
acquiring, based on a first image set including a first image and a second image of a first size, a second image set of a second size smaller than the first size, which corresponds to partial areas of the first image set; and
acquiring a motion vector by inputting the second image set into a machine learning model,
wherein the motion vector is a motion vector in the second image based on the first image,
wherein the machine learning model is trained using a third image set of a third size,
wherein the second size is equal to or smaller than a fourth size, and
wherein the fourth size is set based on the third size.

2. The image processing method according to claim 1, wherein the fourth size is equal to or smaller than 1.5 times as large as the third size.

3. The image processing method according to claim 1, wherein the first size is the number of pixels on one side of each of the first image and the second image.

4. The image processing method according to claim 1, wherein the first size is larger than the fourth size.

5. The image processing method according to claim 1, further comprising:
determining whether or not the second image set is acquired based on the first size and the fourth size;
wherein in a case where the first size is larger than the fourth size, the second image set is acquired, and the motion vector is acquired by inputting the second image set into the machine learning model, and
wherein in a case where the first size is smaller than the fourth size, the motion vector is acquired by inputting the first image set into the machine learning model.

6. The image processing method according to claim 1, wherein the second image set is acquired by reducing the partial areas of the first image set.

7. The image processing method according to claim 1, further comprising:
acquiring, as partial data, at least one of an image acquired based on the second image set and the motion vector, and the motion vector, and concatenating a plurality of partial data corresponding to a plurality of different partial areas.

8. The image processing method according to claim 1, further comprising:
estimating a resolution-improved image corresponding to the second image set by inputting the second image set and the motion vector into the machine learning model.

9. The image processing method according to claim 1, further comprising:
determining the second size based on at least one of the first size, the fourth size, and the machine learning model.

10. The image processing method according to claim 1, wherein the first image and the second image correspond to a plurality of frames at different times in moving image data.

11. The image processing method according to claim 1, wherein a receptive field of the machine learning model is larger than the second size.

12. An image processing method comprising:
reducing a first image and a second image that include at least a portion of a same object at different positions and generating a third image corresponding to the first image and a fourth image corresponding to the second image;
generating a first motion vector based on the third image and the fourth image using a first machine learning model;
generating a second motion vector by enlarging the first motion vector; and
generating a fifth image based on the first image, the second image, and the second motion vector using a second machine learning model.

13. The image processing method according to claim 12, wherein the first image and the second image are images extracted from the same moving image.

14. The image processing method according to claim 12, wherein the first image and the second image are images acquired by dividing a first original image and a second original image, respectively.

15. The image processing method according to claim 12, wherein the fifth image is an image corresponding to the first image and having a resolution higher than that of the first image.

16. The image processing method according to claim 12, wherein the fifth image is an image acquired by upscaling the first image.

17. The image processing method according to claim 12, wherein the fifth image is an image that constitutes a moving image acquired by increasing a frame rate of a moving image including the first image and the second image.

18. The image processing method according to claim 12, wherein enlarging the first motion vector is performed using interpolation processing or a machine learning model that is trained independently of the first machine learning model.

19. The image processing method according to claim 12,
wherein both the third image and the fourth image are images of a first size, and
wherein a first training image set that is used to train the first machine learning model consists of images of the first size or larger.

20. The image processing method according to claim 12,
wherein both the first image and the second image are images of a third size, and
wherein a second training image set that is used to train the second machine learning model consists of images of a fourth size or smaller.

21. A non-transitory computer-readable storage medium storing a program that causes a computer to execute the image processing method according to claim 1.

22. A non-transitory computer-readable storage medium storing a program that causes a computer to execute the image processing method according to claim 12.
